(19) United States
(12) Patent Application Publication
(10) Pub. No.: US 2007/0022074 A1
(43) Pub. Date: Jan. 25, 2007

(54) Inference Information Creating Device

(75) Inventors: Kiyoji Muramatsu, Nagoya-shi, Aichi-ken (JP); Hiroaki Suzuki, Nagoya-shi, Aichi-ken (JP); Satoru Makino, Nagoya-shi, Aichi-ken (JP)

Correspondence Address: BAKER BOTTS LLP;C/O INTELLECTUAL PROPERTY DEPARTMENT, THE WARNER, SUITE 1300, 1299 PENNSYLVANIA AVE, NW, WASHINGTON, DC, 20004-2400, US

(73) Assignee: BROTHER KOGYO KABUSHIKI KAISHA, Nagoya-shi (JP)

(21) Appl. No.: 11/467,056

(22) Filed: Aug. 24, 2006

Related U.S. Application Data
(63) Continuation-in-part of application No. PCT/JP05/02735, filed on Feb. 21, 2005.

(30) Foreign Application Priority Data
Feb. 25, 2004 (JP) 2004-049583
Mar. 4, 2004 (JP) 2004-060760
Mar. 12, 2004 (JP) 2004-071465

(51) Int. Cl. G06F 17/00; G06N 5/02

(52) U.S. Cl. 706/50

(57) ABSTRACT

An inference information creating device includes a measured value acquiring unit, a measured value acquiring unit, an inputting unit, a user input data acquiring unit, and an inferring unit. The measured value acquiring unit acquires a measured value from at least one sensor. A user inputs data on an inference target with the inputting unit. The user input data acquiring unit acquires user input data that the user inputs via the inputting unit. The inferring unit infers the degree of the inference target. The inferring unit includes an inference data creating unit and an inference information outputting unit. The inference data creating unit creates inference data, based on the measured value acquired by the measured value acquiring unit and the user input data acquired by the user input data acquiring unit. The inference data includes an index value different from the measured value that indicates a degree of the inference target. The inference information outputting unit outputs inference information including the inference data created by the inference information creating unit.

### CROSS REFERENCE TO RELATED APPLICATIONS

This application is a continuation-in-part of PCT/JP2005/002735 of an international application designating the United States of America filed on Feb. 21, 2005 (international filing date), and further claims priority based on 35 U.S.C section 119 to Japanese Patent Applications No. 2004-049583 filed Feb. 25, 2004, No. 2004-060760 filed Mar. 4, 2004, and No. 2004-071465 filed Mar. 12, 2004.

### TECHNICAL FIELD

The present invention relates to a device for inferring a user's attitude, emotions, and the like, and particularly to an inference information creating device, an inference information management system, an inference information creating system, a computer readable product, and a method of generating inference information.

### BACKGROUND

Various devices have been proposed for inferring the attitude, emotions, and the like of a user. These devices are provided with sensors for measuring the user's physiological information, biological information, and the like and for inferring the user's attitude, emotions, and the like based on the data measured by these sensors.

One attitude level detecting device well known in the art includes, in addition to sensors for measuring such physiological information as heart rate and skin impedance, a CCD camera for detecting the user's posture and movement, and a microphone for detecting the user's voice, enabling the attitude level detecting device to more accurately detect whether the user's attitude level is in a specific state. Further, Japanese Patent Application Publication No. H10-57355 discloses a game controller. The game controller enables a user to input the user's own psychological state deliberately to obtain more accurate input.

### SUMMARY

However, when detecting the user's voice with the microphone, the invention described in Japanese Patent Application Publication No. H10-57355 has difficulty distinguishing the user's voice from ambient noise and disturbances. Consequently, the invention cannot always detect the user's attitude level accurately. Similarly, when detecting the user's posture and movement with the CCD camera, obstructions coming between the CCD camera and the user can prevent the invention from accurately detecting the user's attitude level. Accordingly, the user cannot accurately input the user's own psychological state even when intentionally wishing to do so.

Further, in the invention of Japanese Patent Application Publication No. H10-57355, if biological information measured by sensors indicate that the user's attitude level is in a specific state, the invention will determine that the user's attitude level is in this specific state regardless of any detections by the CCD camera and microphone. Therefore, even if the user intentionally inputs a psychological state through the CCD camera and microphone, this input is not effectively incorporated if the invention has already determined that the user's attitude level is in a specific state.

Therefore, it is an object of the present invention to provide an inference information creating device for creating high-accuracy inference information.

To achieve the above and other objects, one aspect of the present invention provides an inference information creating device including a measured value acquiring unit, a measured value acquiring unit, an inputting unit, a user input data acquiring unit, and an inferring unit.

The measured value acquiring unit acquires a measured value from at least one sensor. A user inputs data on an inference target with the inputting unit. The user input data acquiring unit acquires user input data that the user inputs via the inputting unit. The inferring unit infers the degree of the inference target. The inferring unit includes an inference data creating unit and an inference information outputting unit. The inference data creating unit creates inference data, based on the measured value acquired by the measured value acquiring unit and the user input data acquired by the user input data acquiring unit. The inference data includes an index value different from the measured value that indicates a degree of the inference target. The inference information outputting unit outputs inference information including the inference data created by the inference information creating unit.

In another aspect of the invention, there is provided an inference information management system including above-described inference information creating device and an inference information management device.

The inference information creating device creates inference information indicating a degree of an inference target. The inference information management device is connected to the inference information creating devices via a network and that manages the inference information created by the inference information creating device.

The inference information management device includes an inference information acquiring unit and an inference information storing unit. The inference information acquiring unit acquires the inference information outputted from the inference information creating devices via the network. The inference information storing unit stores the inference information acquired by the inference information acquiring unit.

In another aspect of the invention, there is provided an inference information creating system including a biological sensor, an environmental sensor, and an inference information creating device.

The biological sensor measures a user's biological data. The environmental sensor measures environmental data. The inference information creating device is connected to the biological sensor and the environmental sensor via a network and creates inference information on the user based on the biological data acquired from the biological sensor and the environmental data acquired from the environmental sensor.

The biological sensor includes a biological data measuring unit that measures biological data and a biological data transmitting unit that transmits the biological data measured by the biological data measuring unit to the inference information creating device. The environmental sensors includes an environmental data measuring unit that measures environmental data and an environmental data transmitting unit that transmits the environmental data measured by the environmental data measuring unit to the inference information creating device.

The inference information creating device includes a biological data acquiring unit, an environmental data acquiring unit, an inputting unit, a user input data acquiring unit, and an inferring unit. The biological data acquiring unit receives and acquires biological data transmitted from the biological sensors. The environmental data acquiring unit receives and acquires environmental data transmitted from the environmental sensors. The inputting unit allows a user to input data on an inference target. The user input data acquiring unit acquires user input data that the user has inputted via the inputting unit. The inferring unit that infers a degree of the inference target.

The inferring unit includes an inference data creating unit and an inference information outputting unit. The inference data creating unit creates inference data based on the biological data acquired by the biological data acquiring unit, the environmental data acquired by the environmental data acquiring unit, and the user input data acquired by the user input data acquiring unit. The inference data is an index value that is different from the biological data and the environmental data. The inference information outputting unit outputs inference information including the inference data created by the inference data creating unit.

In another aspect of the invention, there is provided a computer readable product containing an inference information creating program for instructing a computer to function as:

a measured value acquiring unit that acquires measured value from at least one sensor;

a user input data acquiring unit that acquires user input data inputted by the user via an inputting unit that enables a user to input data on an inference target;

an inferring unit that infers a degree of the inference target by creating the inference data based on the measured value and the user input data, the inference data being an index value that is different from the measured value; and

an inference information outputting unit that outputs the inference information including the inference data.

In another aspect of the invention, there is provided a method of generating inference information including:

acquiring a measured value from at least one sensor;

acquiring user input data on an inference target;

creating inference data based on the measured value and the user input data, the inference data being an index value that is different from the measured value; and

outputting inference information including the inference data.

### BRIEF DESCRIPTION OF THE DRAWINGS

In the drawings:

FIG. 1 is a block diagram showing structure of an inference information creating device according to a first embodiment of the present invention;

FIG. 2 is an explanatory diagram showing structure of a storage area in a RAM provided in the inference information creating device of FIG. 1;

FIG. 3 is an explanatory diagram showing structure of a storage area on a hard disk drive provided in the inference information creating device of FIG. 1;

FIG. 4A is a main flowchart illustrating steps in an inference data creating process according to the first embodiment;

FIG. 4B is a flowchart illustrating detailed steps of S7 in FIG. 4A;

FIG. 5 is a flowchart illustrating detailed steps of a process for initializing sensor values (S1) in FIG. 4A;

FIG. 6 is a flowchart illustrating detailed steps of “sensor output mode 1” (S7) in FIG. 4B;

FIG. 7 is a flowchart illustrating detailed steps of an inference execution process (S111) based on the measured sensor values in FIG. 6;

FIG. 8A is an explanatory diagram showing data structure of an inference definition table for “excitement” according to the first embodiment;

FIG. 8B is an explanatory diagram showing data structure of an inference definition table for “sadness” according to the first embodiment;

FIG. 8C is an explanatory diagram showing data structure of an inference definition table for “joy” according to the first embodiment;

FIG. 9 is a flowchart illustrating detailed steps of “sensor output mode 2” (S8) in FIG. 4B;

FIG. 10 is a flowchart illustrating detailed steps of “switch output mode” (S9) in FIG. 4B;

FIG. 11 is a flowchart illustrating detailed steps of “switch priority mode” (S10) in FIG. 4B;

FIG. 12 is a flowchart illustrating detailed steps of “switch calibration mode 1” (S11) in FIG. 4B;

FIG. 13 is a flowchart illustrating detailed steps of “switch calibration mode 2” (S12) in FIG. 4B;

FIG. 14 is a flowchart illustrating detailed steps of “switch state calibration mode” (S13) in FIG. 4B;

FIG. 15 is an explanatory diagram showing data structure of a calibration table used in a switch state calibration mode (S13);

FIG. 16 is a flowchart illustrating detailed steps of an inference information outputting process (S14) in FIG. 4B;

FIG. 17 is an explanatory diagram showing data structure of inference information according to the first embodiment;

FIG. 18 is a block diagram showing overall structure of an inference distribution map generating system according to a second embodiment of the present invention;

FIG. 19 is a block diagram showing structure of an inference information creating device shown in FIG. 18;

FIG. 20 is a block diagram showing structure of an inference distribution map generating device in FIG. 18;

FIG. 21 is a flowchart illustrating detailed steps of an inference information outputting process (S14) executed by the inference information creating device according to the second embodiment;

FIG. 22 is an explanatory diagram showing data structure of inference information according to the second embodiment;

FIG. 23 is a main flowchart illustrating steps in an inference distribution map generating process executed by the inference distribution map generating device according to the second embodiment;

FIG. 24 is a flowchart illustrating detailed steps of an inference distribution map drawing process (S402) in FIG. 23;

FIG. 25 is an explanatory diagram illustrating process of generating an inference distribution map in the inference distribution map drawing process (S402);

FIG. 26 is another explanatory diagram illustrating process of generating an inference distribution map in the inference distribution map drawing process (S402);

FIG. 27 is an explanatory diagram showing an example inference distribution map created in the inference distribution map drawing process (S402);

FIG. 28 is an explanatory diagram showing another example inference distribution map created in the inference distribution map drawing process (S402);

FIG. 29 is an explanatory diagram showing another example inference distribution map created in the inference distribution map drawing process (S402);

FIG. 30 is an explanatory diagram showing structure of a storage area on a hard disk drive in an inference information creating device according to a third embodiment of the present invention;

FIG. 31 is a flowchart illustrating detailed steps in the inference information outputting process (S14) according to the third embodiment;

FIG. 32 is an explanatory diagram illustrating data structure of inference information created according to the third embodiment;

FIG. 33 is a main flowchart illustrating steps in an inference information characteristic-based process according to the third embodiment;

FIG. 34 is an explanatory diagram showing data structure of a characteristics data table according to the third embodiment;

FIG. 35 is a flowchart illustrating detailed steps in a characteristic-based process A in FIG. 33;

FIG. 36 is a flowchart illustrating detailed steps in a characteristic-based process B in FIG. 33;

FIG. 37 is a flowchart illustrating detailed steps in a characteristic-based process C in FIG. 33;

FIG. 38 is a flowchart illustrating detailed steps in a characteristic-based process D in FIG. 33;

FIG. 39 is a block diagram showing the overall structure of an inference information management system according to a fourth embodiment of the present invention;

FIG. 40 is a flowchart illustrating detailed steps in the inference information outputting process (S14) according to the fourth embodiment;

FIG. 41 is an explanatory diagram illustrating data structure of inference information created according to the fourth embodiment;

FIG. 42 is a main flowchart illustrating steps in an inference information characteristic-based process according to the fourth embodiment;

FIG. 43 is a block diagram showing structure of an inference information creating device according to a fifth embodiment of the present invention;

FIG. 44 is a flowchart illustrating detailed steps in a measurement values acquiring process according to a fifth embodiment of the present invention;

FIG. 45 is a block diagram showing overall structure of an inference information creating system according to a sixth embodiment of the present invention;

FIG. 46 is a block diagram showing structure of an inference information creating device in FIG. 45;

FIG. 47 is a block diagram showing structure of a body temperature sensor in FIG. 45;

FIG. 48 is a main flowchart illustrating detailed steps of a temperature values transmitting process according to the sixth embodiment;

FIG. 49 is a block diagram showing overall structure of an inference information management system according to a seventh embodiment of the present invention;

FIG. 50 is a block diagram showing structure of an inference information creating device in FIG. 49;

FIG. 51 is a flowchart illustrating detailed steps in the inference information outputting process (S14) according to the seventh embodiment; and

FIG. 52 is a main flowchart illustrating steps in an inference information management process according to the seventh embodiment.

### DETAILED DESCRIPTION

Next, a first embodiment of the present invention will be described while referring to the accompanying drawings. An inference information creating device according to the first embodiment is a small portable terminal. The inference information creating device of the preferred embodiment creates inference information on the user based on data measured by sensors and user-inputted data. The data measured by sensors in the following example are measured quantities of body temperature, perspiration, and heart rate. The example of user-inputted data is switch data indicating the ON/OFF state of switches that the user operates to purposely input a psychological state. Inference information in the preferred embodiment is information on the attitude and emotions of the user, this information being the target of inference. In the preferred embodiment, the target of inference will be the user's “excitement,” and the following description will cover a case of creating inference information corresponding to the level or degree of this “excitement.”

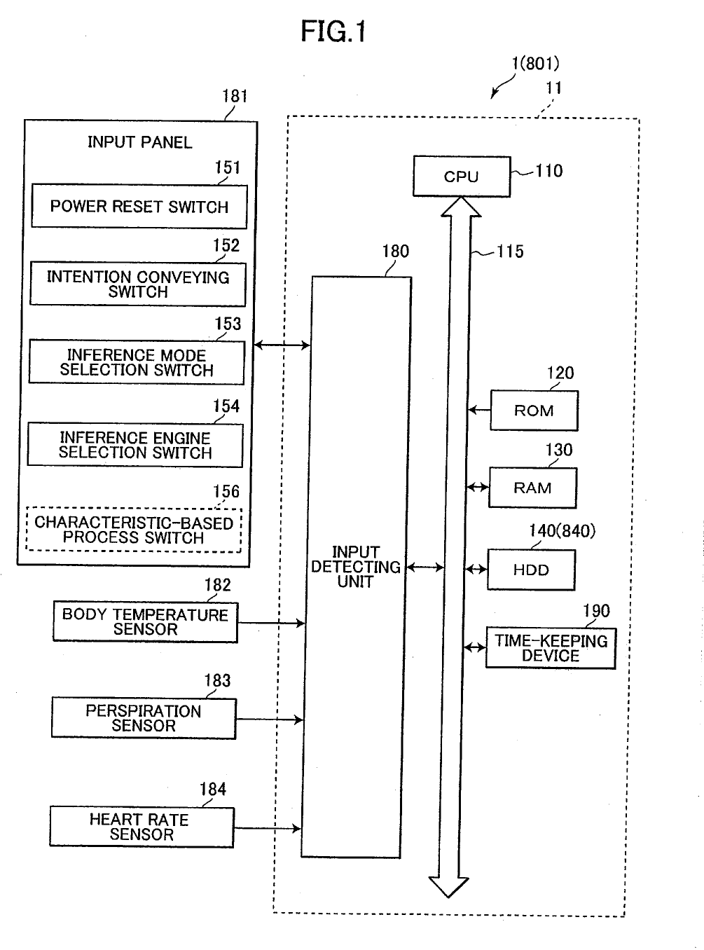

First, the structure of an inference information creating device 1 according to the first embodiment will be described with reference to FIGS. 1 through 3. As shown in FIG. 1, the inference information creating device 1 includes a computer 11. The computer 11 is provided with a CPU 110 for enforcing control of the inference information creating device 1. The CPU 110 is connected via a bus 115 to a ROM 120, a RAM 130 for temporarily storing data, and a hard disk drive (hereinafter referred to as “HDD”) 140 functioning as a data storage device. The ROM 120 stores BIOS and other programs executed by the CPU 110. A time-keeping device 190 for keeping the current date and time and counting time intervals is also connected to the CPU 110 via the bus 115. The time-keeping device 190 is an IC chip provided with a clock function. The time-keeping device 190 may also be configured to acquire the date and time through the Internet or a wireless network.

An input detecting unit 180 is also connected to the CPU 110 via the bus 115 for detecting input from various devices. The input detecting unit 180 is connected to an input panel 181 having various buttons and switches that enable the user to control the inference information creating device 1, a body temperature sensor 182 for measuring the user's body temperature, a perspiration sensor 183 for measuring the perspiration state of the user, and a heart rate sensor 184 for measuring the user's heart rate. If the body temperature sensor 182, perspiration sensor 183, and heart rate sensor 184 can measure the user's body temperature, perspiration, and heart rate effectively, there is no particular stipulation on the positions and measuring methods of these sensors. Reading units of these sensors are preferably placed in contact with the user's skin. The body temperature sensor 182 measures temperatures in the range 0-50° C. The perspiration sensor 183 measures moisture within the range 0-100% RH. The heart rate sensor 184 measures the heart rate within a range 0-200 beats per minute.

After the power to the inference information creating device 1 is turned on and the inference information creating device 1 starts up, these sensors are automatically controlled to perform periodic measurements. Values measured by each sensor are saved in a prescribed storage area within each sensor. The inference information creating device 1 acquires the most recent measured values from the prescribed storage areas via the input detecting unit 180. It is also possible to provide measurement storage areas (not shown) in the RAM 130 or HDD 140 of the inference information creating device 1 for each sensor, and to save measurements acquired from each sensor via the input detecting unit 180 in these measurement storage areas. In this case, the inference information creating device 1 can acquire the latest measurement values by referencing these measurement storage areas.

The input panel 181 is additionally provided with at least a power reset switch 151, an intention conveying switch 152, and an inference mode selection switch 153. The power reset switch 151 turns the power to the inference information creating device 1 on and off to restart the inference information creating device 1. The intention conveying switch 152 inputs switch data when the user switches the intention conveying switch 152 on and off for purposely inputting the user's intention. The input detecting unit 180 acquires switch data from the input panel 181 to determine whether the intention conveying switch 152 is on or off. The inference mode selection switch 153 enables the user to select an inference mode for the inference information creating device 1.

The user switches the intention conveying switch 152 on or off to purposely transmit the user's own intention to the inference information creating device 1. For example, when the inference information creating device 1 is inferring the “excitement” of the user, the user can switch the intention conveying switch 152 on to input “ON” switch data when the user feels excited, and can purposely not turn the intention conveying switch 152 on or can switch the intention conveying switch 152 off to input “OFF” switch data when the user do not feel excited.

The inference information creating device 1 of the first embodiment having this construction creates inference information on the user based on sensor data acquired from the body temperature sensor 182, perspiration sensor 183, and heart rate sensor 184 and switch data acquired from the intention conveying switch 152. An inference information creating program is one module executed on the inference information creating device 1 of the preferred embodiment. The inference information creating program is stored in a program storage area 142 (see FIG. 3) on the HDD 140 in advance. The inference information creating program may be introduced through a CD-ROM drive, floppy (registered trademark) disk drive, and various interfaces not shown in the drawings, and may be installed in the program storage area 142 and a data storage area 143 (see FIG. 3) on the HDD 140 from a CD-ROM or other external storage medium or from an external storage device via a network.

The input panel 181 is also provided with an inference engine selection switch 154 for enabling the user to select a desired inference engine from a plurality of inference engines provided in the inference information creating device 1.

An inference engine is a device having a function to infer the user's attitude and emotions based on data measured by the various sensors. Unique inference techniques and setting conditions are defined for each inference engine. The inference engines include a program for inferring the user's attitude and the like based on measurement values from each sensor and according to these definitions and is executed by the CPU 110 as part of the inference information creating program. As will be described later, the plurality of inference engines is stored on the HDD 140, and the user is allowed to select a desired inference engine.

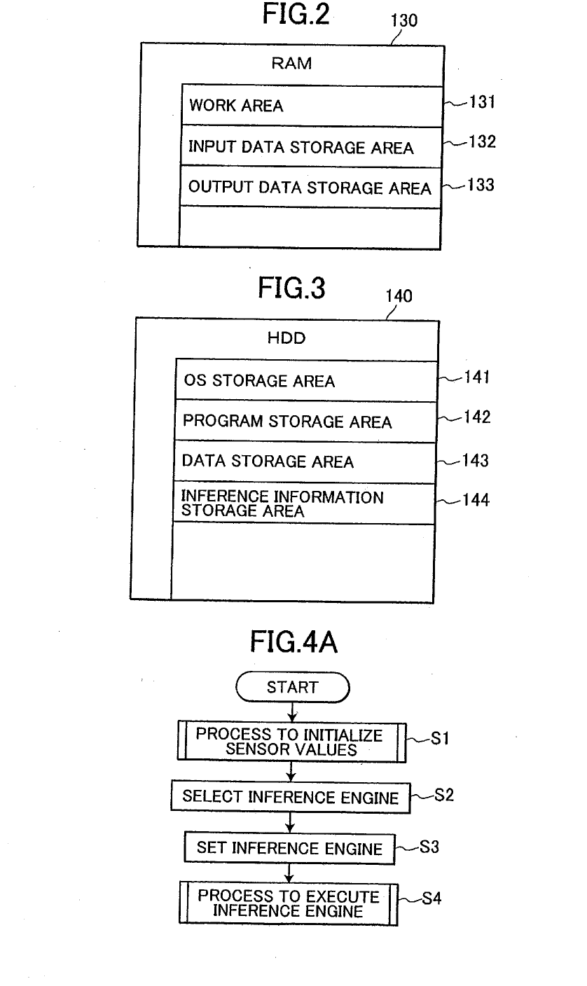

As shown in FIG. 2, the RAM 130 of the inference information creating device 1 is provided with a work area 131, an input data storage area 132, and an output data storage area 133. The work area 131 serves to temporarily store data during the execution of a program. The input data storage area 132 functions to temporarily store various inputted data. The output data storage area 133 functions to temporarily store various data for output. The RAM 130 is also provided with additional storage areas not shown in the drawings.

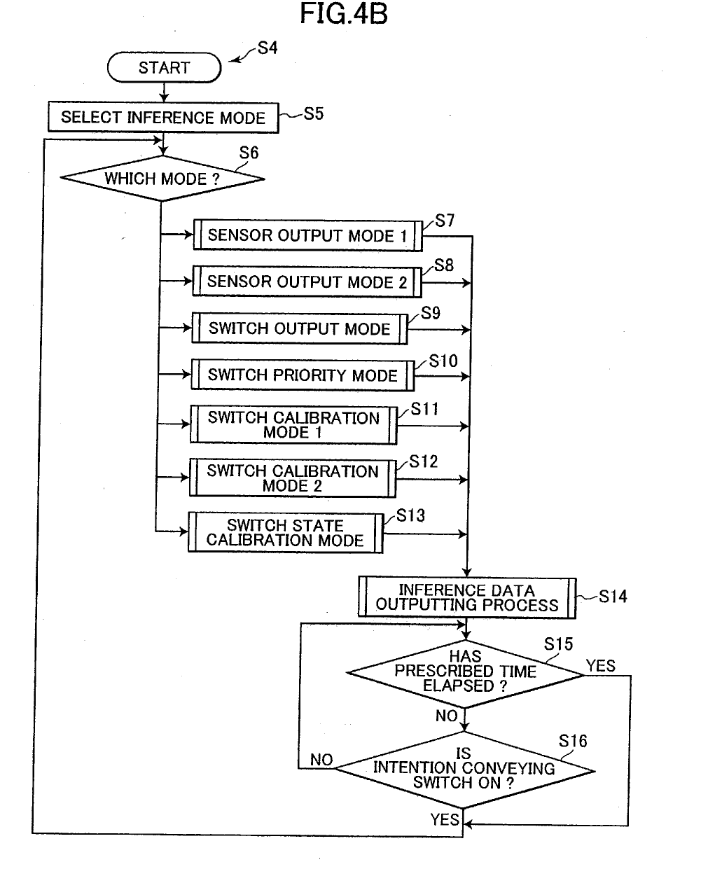

As shown in FIG. 3, the HDD 140 of the inference information creating device 1 is provided with an operating system (OS) storage area 141, the program storage area 142, the data storage area 143, and an inference information storage area 144. The OS storage area 141 stores various programs and the like executed by the CPU 110 for controlling operations of the inference information creating device 1. The program storage area 142 stores the inference information creating program (see FIGS. 4A-7, 9, 14, and 16) and various other programs executed on the inference information creating device 1. The data storage area 143 stores settings, initial values, and other data required for executing programs. The inference information storage area 144 functions to store the generated inference information.

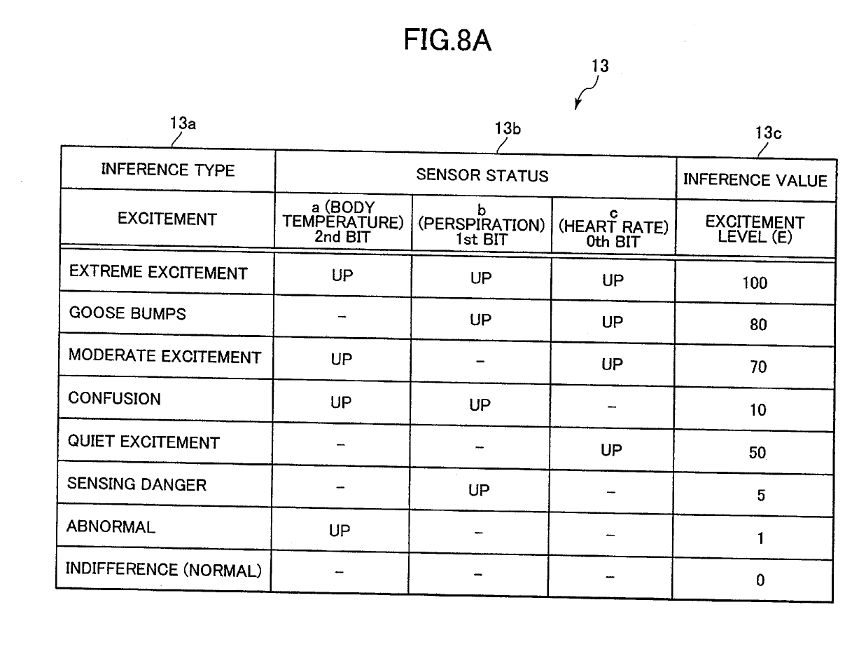

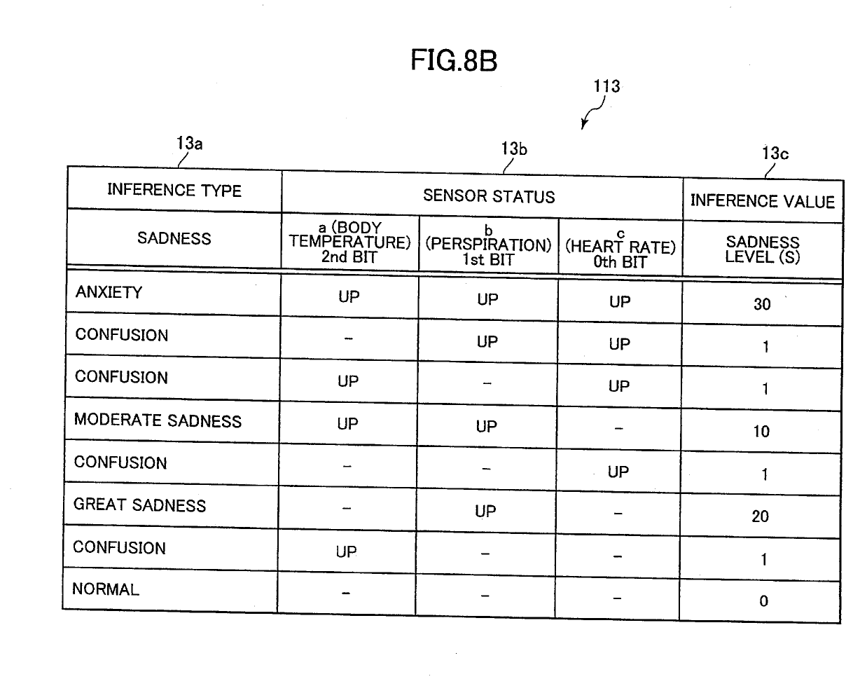

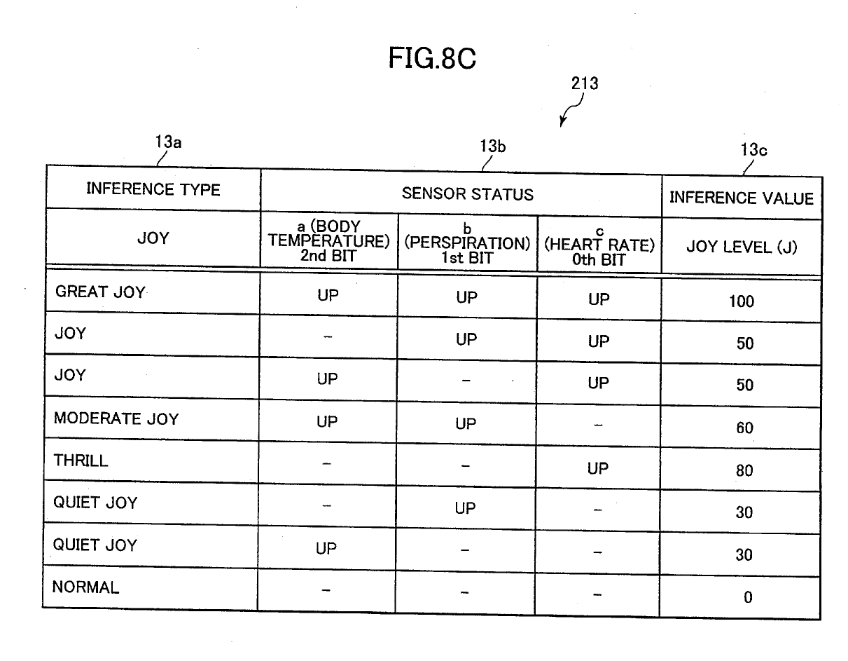

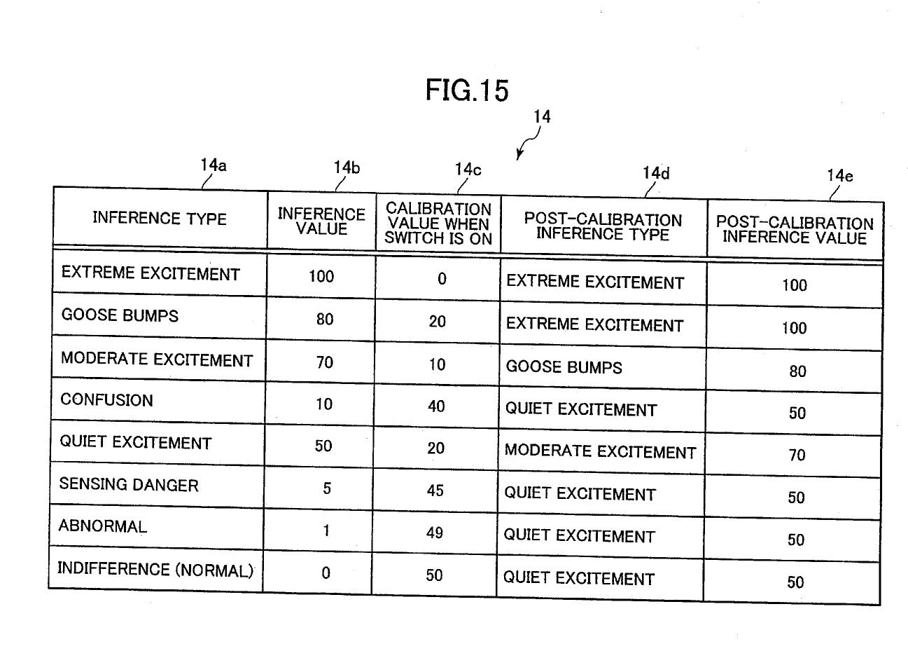

The data storage area 143 stores inference definition tables (FIGS. 8A-8C) and a calibration table (FIG. 15) described later for creating inference data based on measurement data from the sensors. The inference engines (FIGS. 4B, 6, 7, and 9-14) for creating inference data according to different inference techniques are stored in the program storage area 142 as part of the inference information creating program. Further, a plurality of inference programs for implementing a plurality of inference modes are also stored in the program storage area 142 as part of each inference engine.

For example, there is an inference engine for calculating inference values related to “excitement,” that is, an excitement level (E), using an inference definition table 13 in FIG. 8A and creating inference data based on this excitement level (E). There is an inference engine for calculating inference values related to “sadness,” that is, a sadness level (S), using an inference definition table 113 in FIG. 8B, and for creating inference data based on this sadness level (S). There is an inference engine for calculating inference values related to “joy,” that is, a joy level (J), using an inference definition table 213 in FIG. 8C, and for creating inference data based on this joy level (J). The inference definition tables 13, 113, and 213 are stored in the data storage area 143.

Next, steps in the inference information creating process executed by the inference information creating device 1 according to the preferred embodiment will be described with reference to FIGS. 4A through 17. FIG. 4A shows a main flowchart of the inference information creating process that begins when the user operates the power reset switch 151 (FIG. 1) to turn on the power to the inference information creating device 1 or to reset the inference information creating device 1. As shown in FIG. 4A, the CPU 110 first executes a process for initializing sensor values (S1). This process initializes the reference values for each sensor that is referenced in an inference data creating process described later.

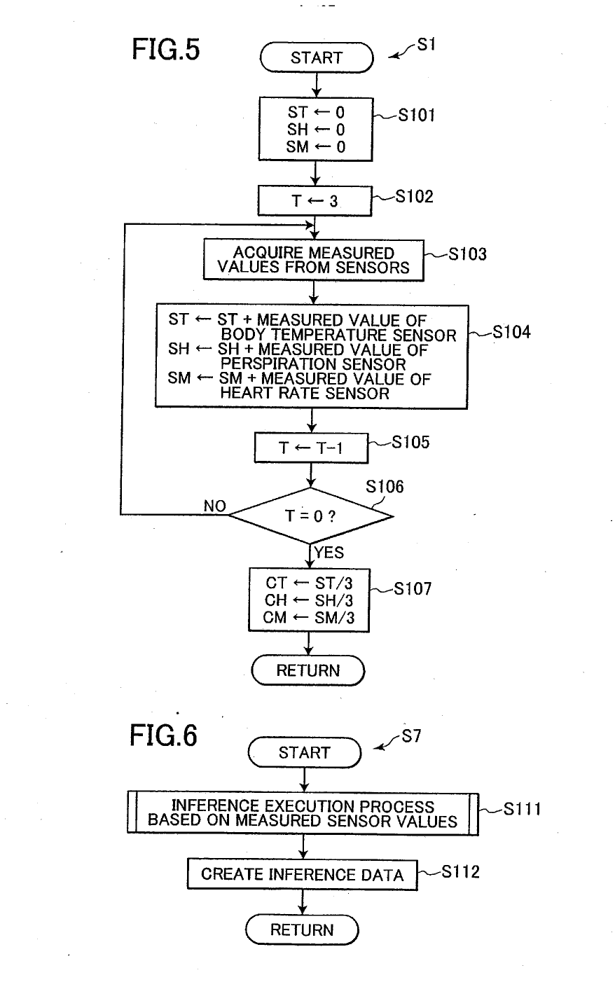

In the initialization process (S1) shown in FIG. 5, the CPU 110 assigns a values “0” to each of the variables ST, SH, and SM (S101) and assigns the value “3” to the variable T (S102). Next, the CPU 110 acquires measured values from each sensor (S103). Specifically, the CPU 110 acquires values for the user's body temperature, perspiration, and heart rate measured by the body temperature sensor 182, perspiration sensor 183, and heart rate sensor 184.

The CPU 110 adds the measured values for body temperature, perspiration, and heart rate obtained from each sensor to the corresponding variables ST, SH, and SM (S104). Since these measured values were acquired for the first time in S103 and since the variables ST, SH, and SM were assigned the value “0” in S101, the variables ST, SH, and SM are essentially assigned the measured values for body temperature, perspiration, and heart rate acquired in S103.

Next, the variable T is decremented by “1” (S105). If T is not “0” (S106: NO), then the CPU 110 returns to S103 to reacquire measured values from each sensor. In this way, the CPU 110 repeats the steps S103-S106 so as to acquire measured values in S103 a number of times corresponding to the number assigned to the variable T in S102 (3 times in this case). As a result, when T reaches “0” (S106: YES), each of the variables ST, SH, and SM hold a sum of measured values, the number measured values being the number originally assigned to the variable T.

Variables CT, CH, and CM are assigned values equivalent to the respect variables ST, SH, and SM divided by the number originally assigned to the variable T, which is “3” in this case. By dividing the sum of the three measured values for each sensor by the number of measurements “3”, the CPU 110 acquires an average value of the measured values for each sensor (reference value for normal operations).

Hence, the variable CT is the reference value for the body temperature sensor 182, the variable CH the reference value for the perspiration sensor 183, and the variable CM the reference value for the heart rate sensor 184. These reference values are saved in a reference value area (not shown) provided in the RAM 130.

Next, the CPU 110 executes an inference engine selection process shown in FIG. 4A (S2). With the inference information creating device 1 of the preferred embodiment, the user can select any of a plurality of inference engines, each of which performs a different process for creating inference data. The inference engines are stored in the program storage area 142. In S2, the CPU 110 determines the inference engine to execute the inference data creating process described later (S4).

The inference engine selection (S2) is achieved by having the user select a desired engine with an inference engine selection switch 154. After the user has selected an inference engine, the CPU 110 loads the inference engine (S3). Specifically, the CPU 110 reads the selected inference engine from the program storage area 142 so that the engine can be executed by the CPU 110. Further, if an inference engine to be executed on the CPU 110 has already been set, this inference engine is automatically read and selected. If the user does not select an inference engine, a default inference engine is set automatically.

Next, in S4 the CPU 110 executes the inference engine selected in S2 and set in S3 in order to perform an inference engine execution process (S4) for creating inference information based on data measured by sensors. The following description is an example of selecting and setting an inference engine for “excitement.” Hence, in S4 the inference information creating device 1 executes an inference engine for “excitement.”

In the inference engine execution process shown in FIG. 4B, first a process for selecting an inference engine is executed (S5). The user can select any of a plurality of inference modes in the inference information creating device 1. Each inference mode has a different process for creating inference data. Inference programs for executing the inference modes are stored in the program storage area 142. The inference program for executing the inference data creating process is set according to the inference mode selected in S5.

The inference mode selection (S5) is achieved by prompting the user to select a desired mode using the inference mode selection switch 153 (FIG. 1). If an inference mode has already been set in the inference information creating device 1, the set inference mode is automatically read and selected. If the user does not select an inference mode, a default inference mode is automatically set.

Next, the CPU 110 determines the content in the inference data creating process based on the inference mode selected in S5 (S6). In the preferred embodiment, one of the inference modes “sensor output mode 1” (S7), “sensor output mode 2” (S8), “switch output mode” (S9), “switch priority mode” (S10), “switch calibration mode 1” (S11), “switch calibration mode 2” (S12), and “switch state calibration mode” (S13) is executed as the inference data creating process. After executing one of the modes in S7-S13, the inference information creating device 1 advances to S14.

The inference data creating process creates inference data based on sensor-measured data and user-inputted data. Steps in the inference data creating process will be described for each inference mode while referring to the drawings.

The “sensor output mode 1” (S7) generates inference data based only on measured sensor values, regardless of on/off switch data from the intention conveying switch 152. In the “sensor output mode 1” (S7) shown in FIG. 6, the CPU 110 executes an inference execution process based on measured sensor values (S111). Inference data including the inference types and inference values acquired in S111 is created (S112). With the “sensor output mode 1” (S7), it is possible to generate inference data based only on measured values from the sensors.

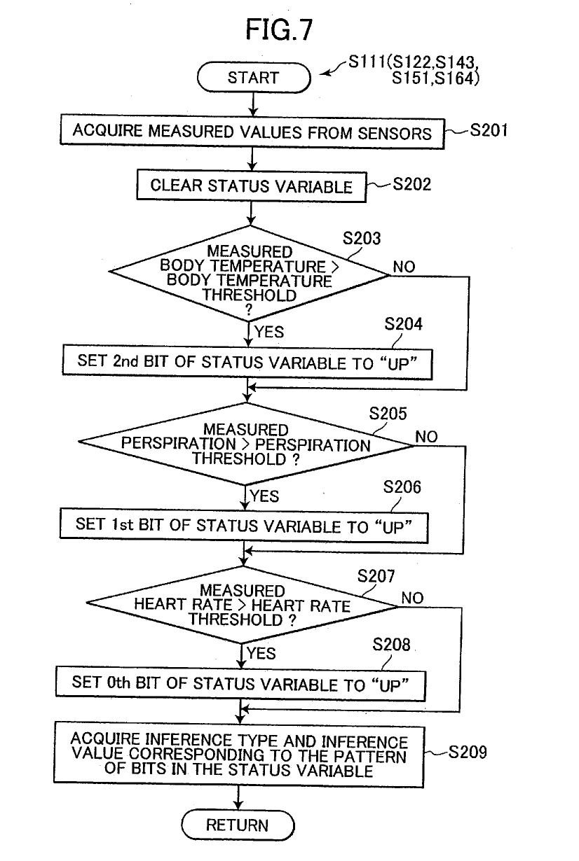

Next, the inference execution process (S111) will be described in detail with reference to FIG. 7. In the inference execution process based on measured sensor values (S111) in FIG. 7, the CPU 110 acquires measured values for the user's body temperature, perspiration, and heart rate measured by the body temperature sensor 182, perspiration sensor 183, and heart rate sensor 184 (S201). Next, the CPU 110 clears a status variable, which includes flags for indicating changes in the states of measured values received from the sensors (S202). In the preferred embodiment, the status variable has three bits. The 2^{nd} bit is used for body temperature measured by the body temperature sensor 182. The 1^{st} bit is used for perspiration measured by the perspiration sensor 183. The 0^{th} bit is used for heart rate measured by the heart rate sensor 184. Beginning from S203 in FIG. 7, the CPU 110 determines whether measured values from the sensors have changed based on the reference values CT, CH, and CM for the sensors calculated in S107 (FIG. 5) and stored in the reference value area (not shown) of the RAM 130.

Specifically, the CPU 110 first compares the measured body temperature acquired from the body temperature sensor 182 with the reference value (body temperature threshold) CT for body temperature (S203). If the measured body temperature is greater than the body temperature threshold CT (S203: YES), then the CPU 110 sets the 2^{nd} bit of the status variable to “UP” (S204). However, if the measured body temperature is not greater than the body temperature threshold CT (S203: NO), then the CPU 110 advances to S205 without changing the status variable. Similarly, the inference information creating device 1 compares the measured perspiration acquired from the perspiration sensor 183 to the reference value for perspiration (perspiration threshold) CH (S205). If the measured perspiration is greater than the perspiration threshold CH (S205: YES), then the CPU 110 sets the 1^{st} bit of the status variable to “UP” (S206). However, if the measured perspiration is not greater than the perspiration threshold CH (S205: NO), then the CPU 110 advances to the next step (S207) without changing the status variable. Further, the CPU 110 compares the measured heart rate acquired from the heart rate sensor 184 to the reference value for heart rate (heart rate threshold) CM (S207). If the measured heart rate is greater than the heart rate threshold CM (S207: YES), then the CPU 110 sets the 0^{th} bit to “UP” (S208). However, if the measured heart rate is not greater than the heart rate threshold CM (S207: NO), then the CPU 110 advances to the next step (S209) without changing the status variable.

In S209 the CPU 110 extracts an inference type 13a and an inference value 13c corresponding to the 2^{nd}, 1^{st}, and 0^{th} bits in the status variable from the inference definition table 13 for “excitement.” As shown in FIG. 8A, the inference definition table 13 includes the data fields of the inference type 13a indicating the type of inference, a sensor state 13b indicating a change in status of the measured sensor value, and the inference value 13c indicating the magnitude of inference numerically. Correlations of these data fields are defined in a table format.

In the inference type 13a, various types of “excitement” have been defined. Specifically, types of “excitement” ranging from “extreme excitement” to “indifference (normal)” have been defined based on a degree of user excitement. The inference value 13c represents these degrees of “excitement” numerically. For example, “extreme excitement” in the inference type 13a is represented with the maximum value “100” in the inference value 13c. The value in the inference value 13c is displayed as the excitement level (E). In S209 the CPU 110 identifies the sensor state 13b based on the status variable set in S203-S208. The CPU 110 then extracts the inference type 13a and inference value 13c corresponding to the sensor state 13b. While the value of the inference value 13c increases as the degree of “excitement” increases in the inference definition table 13 of this example, the values in the inference value 13c may be configured to decrease as the degree of “excitement” increases.

The “sensor output mode 2” (S8) generates inference data based on measured sensor values when the user has switched on the intention conveying switch 152 to input “ON” switch data.

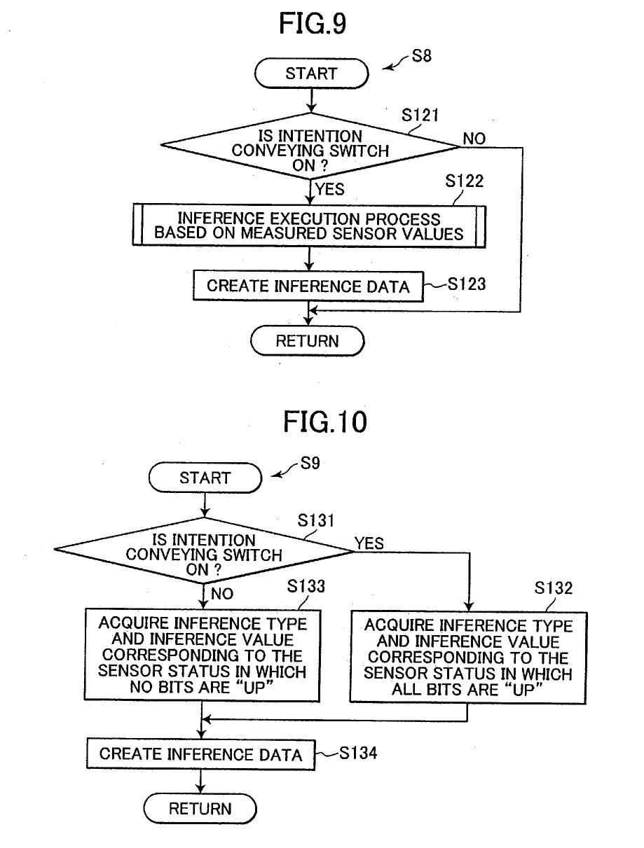

In the “sensor output mode 2” (S8) shown in FIG. 9, the CPU 110 determines whether the intention conveying switch 152 is “ON” (S121). If the intention conveying switch 152 is “ON” (S121: YES), the CPU 110 executes the inference execution process based on measured sensor values (S122). S122 is the same process as S111 described in FIG. 7. Next, the CPU 110 creates inference data including the inference type 13a and inference value 13c acquired in S122 (S123). However, if the intention conveying switch 152 is “OFF” (S121: NO), then the CPU 110 returns to FIG. 4A without generating inference data. Hence, the CPU 110 creates inference data based on the sensor values at a timing at which the user turns on the intention conveying switch 152.

The “switch output mode” (S9) creates inference data based only on ON/OFF switch data inputted by the user via the intention conveying switch 152, with no consideration for the measured values from the sensors.

In the “switch output mode” (S9) shown in FIG. 10, the CPU 110 determines whether the intention conveying switch 152 is “ON” (S131). If the intention conveying switch 152 is “ON” (S131: YES), then the CPU 110 acquires the inference type 13a and inference value 13c from the inference definition table 13 corresponding to the sensor state 13b in which all bits of the status variable are “UP” (S132). Specifically, when all 2^{nd} through 0^{th} bits of the status variable are “UP”, the inference type 13a corresponding to the sensor state 13b is “extreme excitement” and the inference value 13c is “100”. Accordingly, the CPU 110 creates inference data indicating the strongest level of excitement based on the inference type 13a of “extreme excitement” and the inference value 13c of “100” (S134).

However, if the intention conveying switch 152 is “OFF” (S131: NO), then the CPU 110 acquires the inference type 13a and inference value 13c in the inference definition table 13 corresponding to the sensor state 13b in which all of the bits of the status variable are not “UP” (S133). In other words, the CPU 110 acquires the inference type 13a of “indifference (normal)” and the inference value 13c of “0” corresponding to the sensor state 13b when none of the 2^{nd} through 0^{th} bits of the status variable are “UP”. Hence, the CPU 110 creates inference data indicating the lowest level of “excitement” based on the inference type 13a of “indifference (normal)” and the inference value 13c of “0” (S134). Accordingly, the CPU 110 creates inference data based only on switch data indicating whether the user has turned the intention conveying switch 152 on or off.

The “switch priority mode” (S10) creates inference data based on the switch data inputted by the user when the user switches on the intention conveying switch 152 to input “ON” switch data. However, the “switch priority mode” creates inference data based on measured values from the sensors when the user has not turned on the intention conveying switch 152 or has turned off the intention conveying switch 152 to input “OFF” switch data or when switch data is not inputted due to some reason (malfunction or the like).

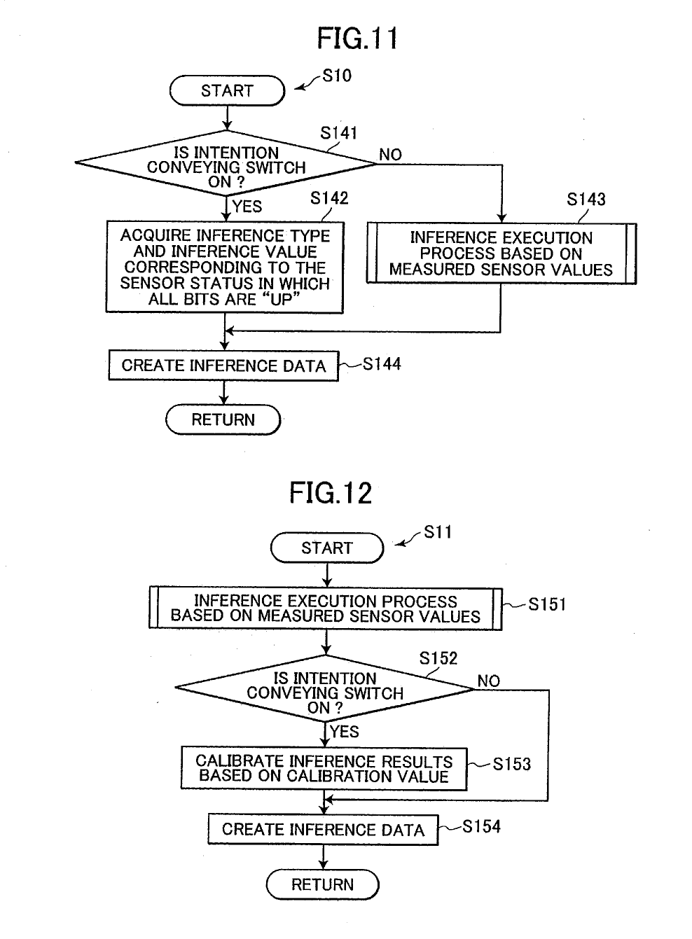

In the “switch priority mode” (S10) shown in FIG. 11, the CPU 110 determines whether the intention conveying switch 152 is “ON” (S141). If the intention conveying switch 152 is “ON” (S141: YES), then the CPU 110 acquires the inference type 13a and inference value 13c from the inference definition table 13 corresponding to the sensor state 13b when all bits of the status variable are “UP” (S142). However, if the intention conveying switch 152 is “OFF” (S141: NO), then the CPU 110 executes the inference execution process according to sensor measured values (S143). The process of S143 is identical to that of S111 described in FIG. 7. Next, the CPU 110 creates inference data including the inference type 13a and inference value 13c acquired in either S142 or S143 (S144). Therefore, when the user switches on the intention conveying switch 152 to input “ON” switch data, the CPU 110 creates inference data based on the user's switch data at the inputted timing of the switch data. However, if the user inputs “OFF” switch data by not turning on the intention conveying switch 152 (switching off the intention conveying switch 152), the CPU 110 creates inference data based on measured values from the sensors.

The “switch calibration mode 1” (S11) first performs an inference based on the measured values from the sensors. Next, the “switch calibration mode 1” creates inference data by calibrating the inference results using a prescribed calibration value when the user has switched on the intention conveying switch 152 to input “ON” switch data. The “switch calibration mode 1” outputs the inference results without calibration if the user has not switched on the intention conveying switch 152 or has switched off the intention conveying switch 152 to input “OFF” switch data.

In the “switch calibration mode 1” (S11) shown in FIG. 12, the CPU 110 executes an inference execution process according to measured values (S151). The process of S151 is identical to S111 described in FIG. 7. Next, the CPU 110 determines whether the intention conveying switch 152 is “ON” (S152). If the intention conveying switch 152 is “ON” (S152: YES), then the CPU 110 calibrates the inference results of S151 according to the prescribed calibration value (S153). For example, if a calibration value a equals 20 and the inference type 13a and inference value 13c acquired in S151 are “quiet excitement” and “50”, respectively, the CPU 110 adds the calibration value α=20 to the inference value 13c=“50” so that the inference results are calibration to an inference type 13a of “moderate excitement” and a inference value 13c of “70”.

Next, the CPU 110 creates inference data including the calibrated inference type 13a and inference value 13c (S154). Accordingly, the CPU 110 calibrates the inference results with the prescribed calibration value when the user has switched on the intention conveying switch 152 to input “ON” switch data. However, if the intention conveying switch 152 is “OFF” (S152: NO), then the CPU 110 creates inference data including the inference type 13a and inference value 13c acquired in S151 (S154). Here, the calibration value α may be set to a value that greatly reflects the effect of switching on the intention conveying switch 152 or, more specifically, a value equivalent to 30% of the inference value 13c.

Next, the “switch calibration mode 2” (S12) acquires measured values from each sensor and calibrates the measured values using a predetermined calibration value when the user has turned on the intention conveying switch 152 to input “ON” switch data. The CPU 110 executes the inference execution process using the calibrated sensor values. However, if the user has not turned on the intention conveying switch 152 (turned off the intention conveying switch 152), inputting “OFF” switch data, the CPU 110 executes the inference execution process using the normal sensor values to create inference data.

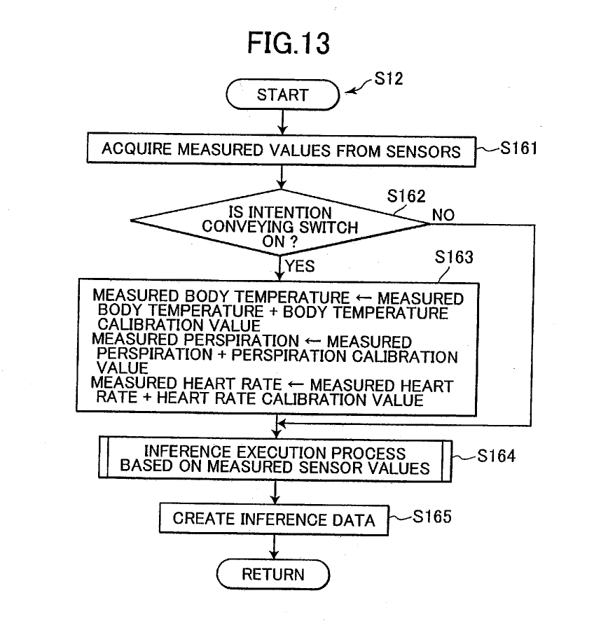

In the “switch calibration mode 2” (S12) shown in FIG. 13, the CPU 110 first acquires measured values from each sensor, as in S201 of FIG. 7 (S161). Next, the CPU 110 determines whether the intention conveying switch 152 is “ON” (S162). If the intention conveying switch 152 is “ON” (S162: YES), then the CPU 110 calibrates the measured sensor values acquired in S161 using the predetermined calibration value (S163). Here, calibration values are preset for each sensor, and the calibration process is executed on the measured values of each sensor. For example, a body temperature calibration value of 1° C. may be added to the measured body temperature value of 36° C. to obtain a calibrated body temperature value of 37° C.

Similarly, the measured perspiration value is calibrated with a perspiration calibration value, and the measured heart rate value is calibrated with a heart rate calibration value. Accordingly, the measured values of each sensor can be calibrated with prescribed calibration values when the user has switched on the intention conveying switch 152 to input “ON” switch data. Next, the CPU 110 executes the inference execution process using the calibrated sensor values (S164). However, if the intention conveying switch 152 is “OFF” (S162: NO), then the CPU 110 executes the inference process using the measured values of each sensor obtained in S161 (S164). The process of S164 is identical to the process of S111 described in FIG. 7, excluding the process to acquire measured values from each sensor (S201). Next, the CPU 110 creates inference data including the inference type 13a and inference value 13c acquired in S164 (S165).

The “switch state calibration mode” (S13) first performs inference based on measured values from the sensors. When the user has switched on the intention conveying switch 152 to input “ON” switch data, the CPU 110 calibrates the inference results using a calibration value defined in a calibration table 14 to generate inference data. However, when the user has not turned on the intention conveying switch 152 (has turned off the intention conveying switch 152) to input “OFF” switch data, the CPU 110 outputs the inference results without calibration.

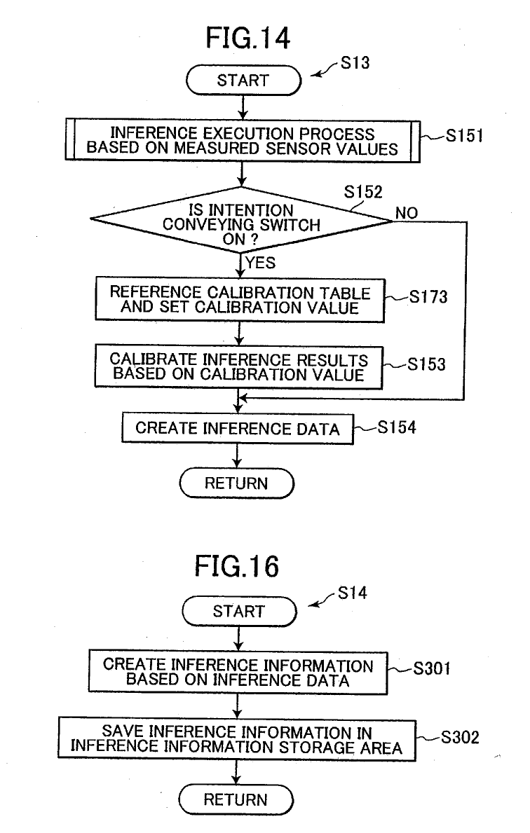

The “switch state calibration mode” (S13) shown in FIG. 14 is identical to the “switch calibration mode 1” (S11) shown in FIG. 12, except that a step S173 has been added between steps S152 and S153. Specifically, while calibration values are preset in the “switch calibration mode 1” (S11), the CPU 110 sets calibration values by referencing the calibration table 14 in S173 of the “switch state calibration mode” (S13).

As shown in FIG. 15, the calibration table 14 includes inference types 14a and inference values 14b that are the target of calibration, calibration values 14c that are added to the calibration target when the intention conveying switch 152 is on, and inference types 14d and inference values 14e after calibration. In S173 the CPU 110 searches the calibration table 14 for the inference type 14a and inference value 14b corresponding to the inference type 13a and inference value 13c acquired in S151. Subsequently, the CPU 110 acquires the calibration value 14c corresponding to the searched inference type 14a and inference value 14b. After performing calibration using the calibration value 14c, the CPU 110 obtains the post-calibration inference type 14d and inference value 14e. When the user has switched on the intention conveying switch 152 to input “ON” switch data, the CPU 110 can calibrate the inference results based on the calibration value defined in the calibration table 14. For example, if the CPU 110 acquires “quiet excitement” and “50” for the inference type 14a and inference value 14b in S151 and the user has switched on the intention conveying switch 152, then the CPU 110 acquires the calibration value 14c “20” from the calibration table 14 and performs calibration using the calibration value 14c to obtain a inference type 14d of “moderate excitement” and a inference value 14e of “70”.

In this way, the inference information creating device 1 executes each the inference program for directing the CPU 110 to implement the inference mode according to the mode selected in S6. As a result, the CPU 110 performs the respective inference data creating process (S7, S8, S9, S10, S11, S12, or S13) to generate inference data.

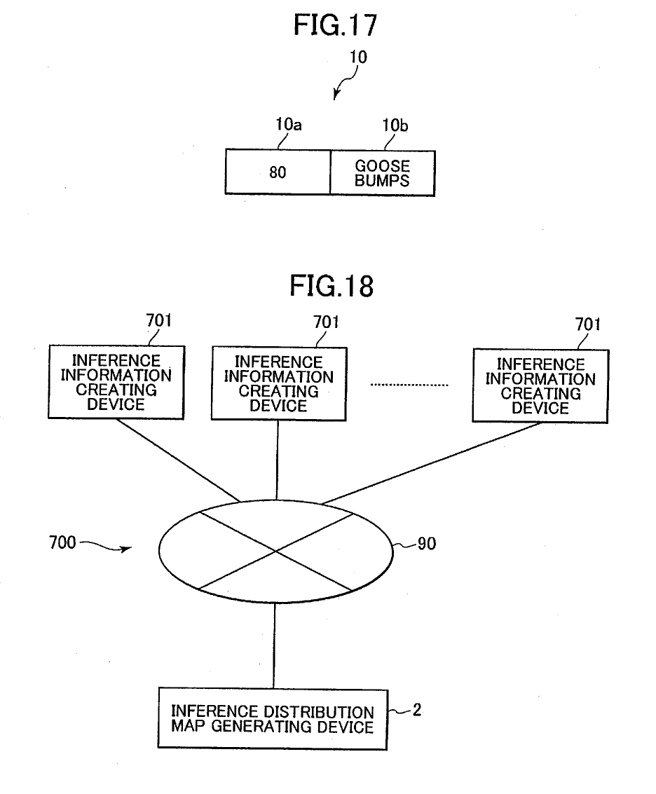

By providing a plurality of inference modes and allowing the user to select a desired inference mode with the inference mode selection switch 153, the inference information creating device 1 can generate highly accurate inference data using an optimal inference mode for the usage conditions, environmental factors, and the like. For example, the inference information creating device 1 offers various formats, including the “switch output mode” (S9) when it is desirable to create inference information 10 (see FIG. 17) based on switch data inputted by the user, “sensor output mode 1” (S7) when it is desirable to create the inference information 10 based on measured values from the sensors, and “switch calibration mode 1” (S11) when it is desirable to calibrate the inference information 10 based on switch data inputted by the user-friendly. Therefore, the inference information creating device 1 can create more accurate inference data on the user.

The inference information creating device 1 includes inference modes for outputting inference data indicating strong inferred emotions, attitude, and the like when the user switches on the intention conveying switch 152 to input “ON” switch data, thereby reflecting data inputted by the user in the inference data. Further, more accurate inference data is obtained by reflecting measurements of the user's body temperature, perspiration, and heart rate in the inference data. Here, it is possible to use only one of the measurement for body temperature, perspiration, and heart rate, and accurate inference data can be obtained when using only one of these measured values.

For example, when the switch data is “ON” in the “switch output mode” (S9), the inference information creating device 1 generates inference data indicating the strongest “excitement.” Further, when the switch data is “ON” in “switch calibration mode 1” (S11), the CPU 110 adds the calibration value to the inference results and generate inference data indicating greater “excitement” of the user. Hence, when the user recognizes that he or she is excited and immediately switches on the intention conveying switch 152, for example, the inference information creating device 1 creates inference data indicating that the user is highly excited. In this way, switch data for “excitement” that is inputted by the user can be reflected in the inference data.

Next, the CPU 110 executes an inference information outputting process (S14), as shown in FIG. 4(b) for outputting the inference data generated in one of the inference data creating processes described above. In the inference information outputting process (S14) shown in FIG. 16, the CPU 110 creates the inference information 10 based on inference data created in one of the inference data creating processes (S7-S13; S301). As shown in FIG. 17, the inference information 10 includes at least an inference value 10a and an inference type 10b. The inference value 10a and inference type 10b correspond to the inference value 13c and inference type 13a, respectively, in the inference data. The CPU 110 saves the inference information 10 generated in S301 in the inference information storage area 144 (FIG. 3) of the HDD 140 (S302).

Subsequently, the CPU 110 determines whether a prescribed time has elapsed (S15; FIG. 4(b)). The prescribed time has been preset in the time-keeping device 190. Hence, the CPU 110 references the time-keeping device 190 in S15 to determine whether the prescribed time has elapsed. The prescribed time set in the time-keeping device 190 can be an arbitrary time set by the user or the designer.

If the prescribed time has not elapsed (S15: NO), then the CPU 110 determines whether the intention conveying switch 152 is “ON” (S16). If the intention conveying switch 152 is not “ON,” that is, when the intention conveying switch 152 is “OFF” (S16: NO), the CPU 110 returns to S15. Accordingly, the CPU 110 loops between S15 and S16 until either the prescribed time has elapsed or the intention conveying switch 152 has been turned “ON.”

However, if either the prescribed time has elapsed (S15: YES) or the intention conveying switch 152 is “ON” (S16: YES), the CPU 110 returns to S6 to select an inference mode, executes one of the inference data creating processes (S7-S13) to generate inference data, and outputs the inference information 10 (S14). Hence, the CPU 110 repeats a process to output the most recent inference information 10 at prescribed time intervals or each time the intention conveying switch 152 is switched on. Consequently, a plurality of inference information 10 regarding the user is saved over time in the inference information storage area 144 of the HDD 140 (FIG. 3).

Since an inference engine related to “excitement” was selected and set in S2 and S3 in the example described above, the CPU 110 executed the processes in FIGS. 4B-7 and 9-14 and created inference data using the inference definition table 13. However, if an inference engine related to “sadness” is selected and set in S2 and S3, the “sadness” inference engine is executed in S4. In this case, the CPU 110 performs the processes in FIGS. 4B-7 and 9-14 in S4 as in the case of “excitement,” except the CPU 110 uses the inference definition table 113 in place of the inference definition table 13 in S209 (FIG. 7). In the inference definition table 113 for “sadness” shown in FIG. 8B, the inference type 13a defines a plurality of types of “sadness” based on the degree of the user's “sadness,” including “anxiety,” “great sadness,” and “normal.” The degree of “sadness” is also represented numerically by the inference value 13c. For example, the inference value 13c is the maximum value “30” when the inference type 13a is “anxiety.” In S209 the CPU 110 identifies the sensor state 13b based on the results in S203-S208 and acquires the inference type 13a and inference value 13c corresponding to this sensor state 13b from the inference definition table 113.

Similarly the CPU 110 executes an inference engine for “joy” in S4 when an inference engine for “joy” has be selected and set in S2 and S3. In this case as well, the CPU 110 executes processes in FIGS. 4(b)-7 and 9-14 in S4, as in the case of “excitement,” except the CPU 110 uses the inference definition table 213 in place of the inference definition table 13 in S209 (FIG. 7). In the inference definition table 213 shown in FIG. 8C, the inference type 13a defines types of “joy,” and the inference value 13c represents the degree of “joy” numerically. Hence, after identifying the sensor state 13b, the CPU 110 extracts the inference type 13a and inference value 13c corresponding to the sensor state 13b from the inference definition table 213.

As described above, the inference information creating device 1 of the first embodiment generates the inference information 10 based on measured values acquired from each of the body temperature sensor 182, perspiration sensor 183, and heart rate sensor 184 and switch data inputted when the user switches on and off the intention conveying switch 152. Therefore, the inference information creating device 1 can create highly accurate inference information 10. Specifically, when the user inputs desired switch data, the inference information creating device 1 reflects the user's attitude, emotions, and the like in the inference information 10. Therefore, the inference information creating device 1 can further improve the accuracy of the inference information 10. Since the inference mode can be set arbitrarily, the inference information creating device 1 can reflect switch data inputted by the user in the inference information 10. Further, by providing a plurality of inference engines and allowing the user to select a desired inference engine, the inference information creating device 1 can generate inference data using an inference engine most suited to the conditions and the environment in which the inference information creating device 1 is used, thereby enabling the creation of more accurate inference data on the user.

Next, an inference distribution map generating system 700 according to a second embodiment of the present invention will be described with reference to FIGS. 18 through 29. The inference distribution map generating system 700 includes inference information creating devices, which are small portable terminals; and an inference distribution map generating device, which is a stationary computer that connects with the inference information creating devices via a network. In the inference distribution map generating system 700 of the preferred embodiment, a plurality of the inference information creating devices generate inference information that it is collected by the inference distribution map generating device via the network. The inference distribution map generating device creates a distribution map with the inference information.

First, the structure of the inference distribution map generating system 700 according to the second embodiment will be described with reference to FIGS. 18 through 20. As shown in FIG. 18, the inference distribution map generating system 700 includes a plurality of inference information creating devices 701, and an inference distribution map generating device 2 that is connected to each of the inference information creating devices 701 via a network 90. The network 90 may be any wired or wireless network that can effectively connect various terminals for data communications.

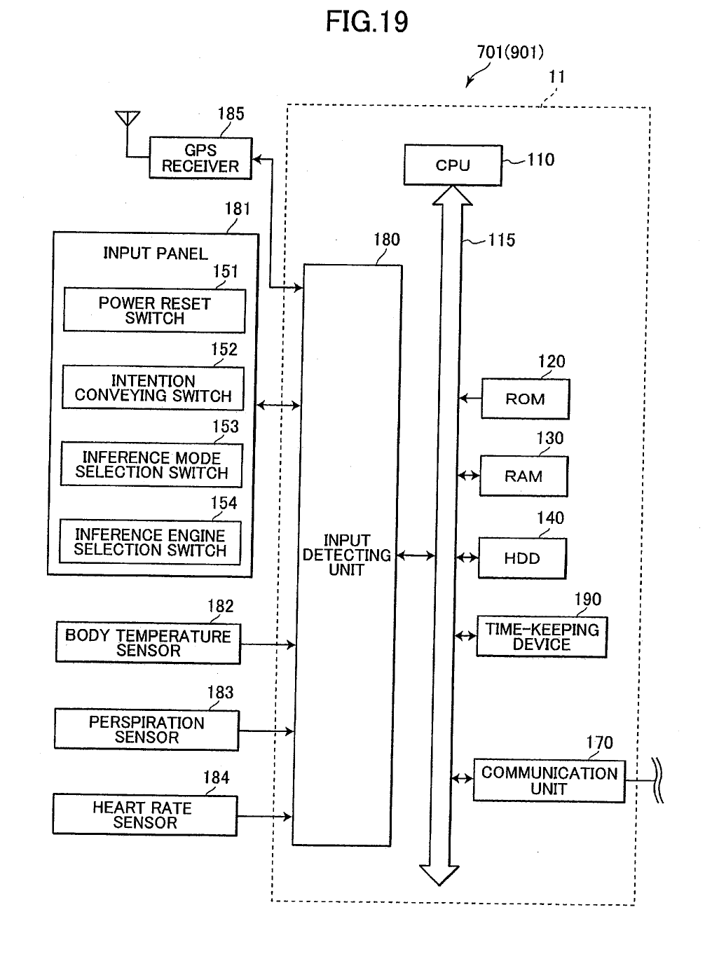

As shown in FIG. 19, each inference information creating device 701 has a similar construction to the inference information creating device 1 (FIG. 1) according to the first embodiment, but is also provided with a GPS receiver 185, and a communication unit 170. The GPS receiver 185 receives radio waves from an artificial satellite and measures the latitude and longitude to detect the current position. The communication unit 170 connects the computer 11 to an external network 90 through a wired or wireless connection, provided that the computer 11 can be effectively connected to the network 90. For example, the communication unit 170 in the preferred embodiment is a wireless LAN adapter that connects to the network 90 through a wireless LAN.

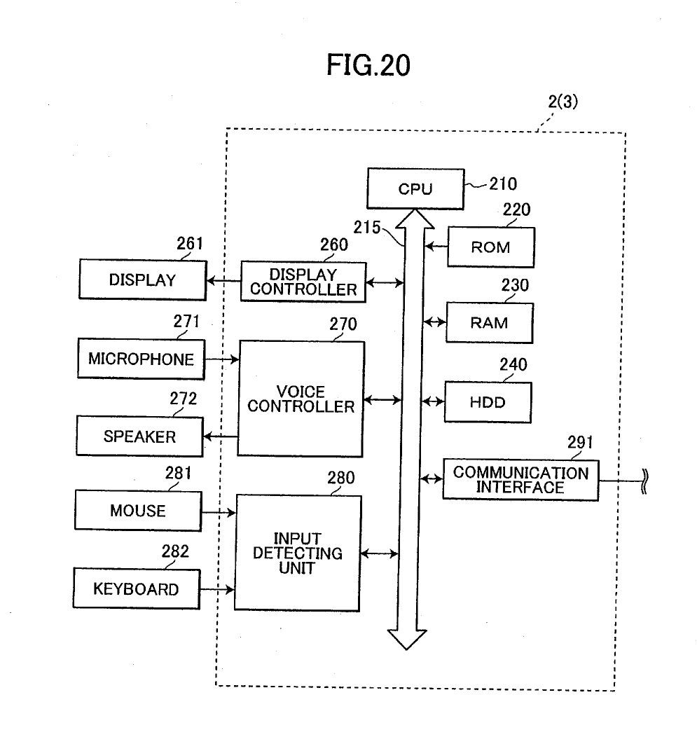

As shown in FIG. 20, the inference distribution map generating device 2 includes a CPU 210, a ROM 220, a RAM 230, a HDD 240, a display controller 260, a voice controller 270, and an input detecting unit 280 that are all connected via a bus 215. The display controller 260 connects to a display 261. The voice controller 270 connects to a microphone 271 and a speaker 272. The input detecting unit 280 connects to a mouse 281 and a keyboard 282. Since the structure of the inference distribution map generating device 2 is identical to a common computer well known in the art, a detailed description of the structure has been omitted. The inference distribution map generating device 2 is also provided with a communication interface 291 for forming a wired or wireless connection with the network 90. The communication interface 291 may be any interface that is capable of effectively connecting with the network 90. For example, the communication interface 291 in the preferred embodiment is a LAN card that connects by a cable to a wired LAN.

In the preferred embodiment, the inference information creating device 701 executes an “inference information creating process” for generating inference information based on user-inputted switch data and sensor-measured values. Here, the “inference information creating process” of the second embodiment is identical to the “inference information creating process” described in FIGS. 4A-17, except for the process of S14.

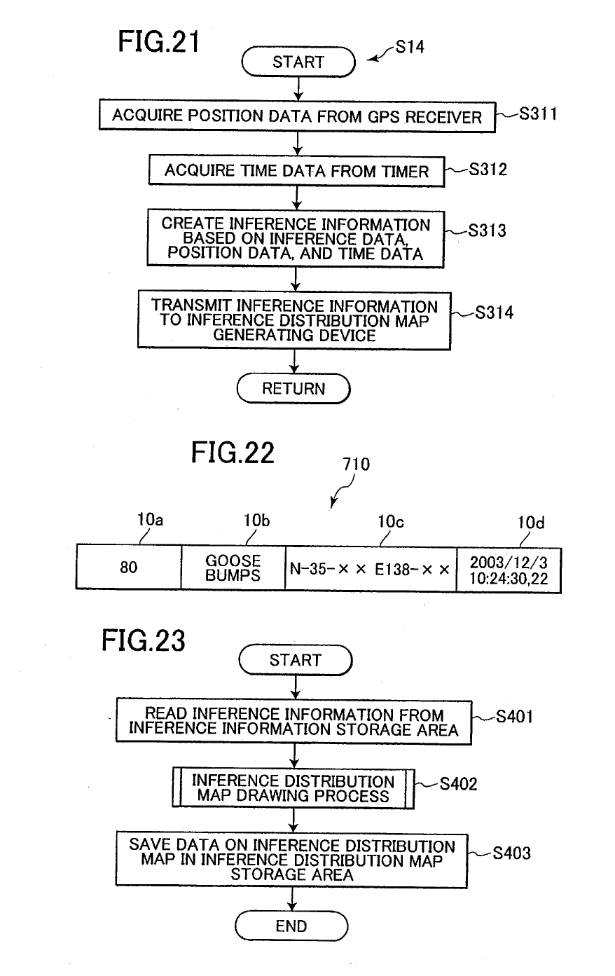

In the inference information outputting process (S14) of the preferred embodiment shown in FIG. 21, the inference information creating device 701 references the GPS receiver 185 to acquire position data indicating the current position (S311) and references the time-keeping device 190 to acquire time data indicating the current date and time (S312). Next, the inference information creating device 701 creates inference information 710 based on the inference data created in one of the inference data creating processes (S7, S8, S9, S10, S11, S12, or S13), the position data acquired in S311, and the date and time data acquired in S312 (S313). The inference information creating device 701 transmits the inference information 710 generated in S313 to the inference distribution map generating device 2 via the communication unit 170 and network 90 (S314).

As shown in FIG. 22, the inference information 710 includes at least an inference value 10a, an inference type 10b, position data 10c, and time data 10d. In the preferred embodiment, the position data 10c and time data 10d can be outputted owing to the provision of the GPS receiver 185 and time-keeping device 190, respectively. The inference value 10a and inference type 10b correspond to the inference value 13c and inference type 13a in the inference data of the first embodiment. The position data 10c corresponds to the position data acquired in S311, and the time data 10d corresponds to the date and time data acquired in S312. The position data 10c need not be absolute coordinates but may be relative coordinates.

The inference distribution map generating device 2 receives the inference information 710 transferred from the inference information creating device 701 via the network 90 by the communication interface 291. The inference distribution map generating device 2 saves the inference information 710 in an inference information storage area not shown in the drawings provided in the HDD 240 of the inference distribution map generating device 2.

The CPU 210 of the inference distribution map generating device 2 executes an inference distribution map generating process for creating a distribution map of inference information based on a plurality of inference information samples collected in the inference information storage area (not shown). The inference distribution map generating device 2 executes the inference distribution map generating process periodically at predetermined intervals or when commanded by an operation on the mouse 281 or keyboard 282.

In the inference distribution map generating process shown in FIG. 23, the CPU 210 reads the inference information 710, for which a distribution map is to be created, from the inference information storage area (not shown) (S401). At this time, the CPU 210 may read all of the inference information 710 saved in the inference information storage area or may read only a portion of the saved inference information 710. It is also possible to allow the user to select the inference information 710 to be read.

Next, the CPU 210 executes an inference distribution map drawing process (S402) based on the inference information 710 read in S401 to create an inference distribution map of the inference information 710. Data for the inference distribution map created in S402 is saved in an inference distribution map storage area (not shown) in the HDD 240 (S403).

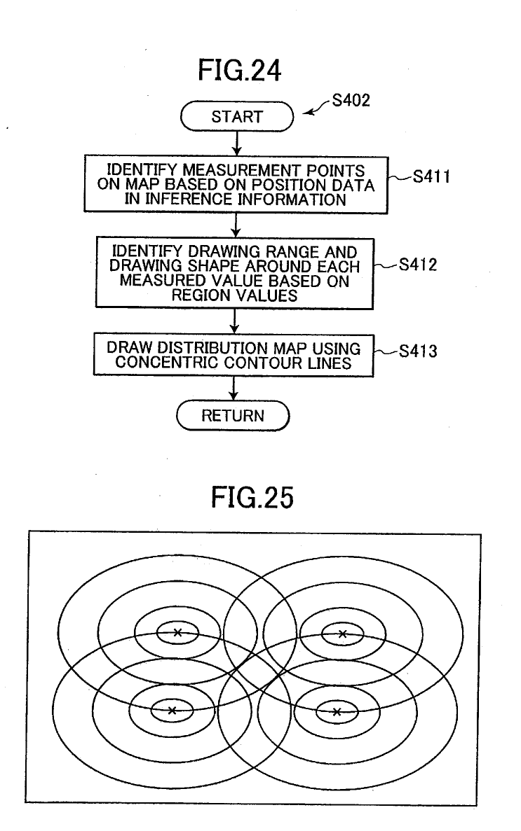

Next, the inference distribution map drawing process (S402) will be described in detail with reference to FIG. 24. A variety of methods for creating distribution maps may be used for creating the distribution map based on the inference information 710. Hence, the steps in the inference distribution map drawing process (S402) will differ according to the method used for generating the inference distribution map. As an example, a description will be given here for creating an inference distribution map based on the distribution of contour lines in concentric circular shapes.

In the inference distribution map drawing process (S402) shown in FIG. 24, the CPU 210 specifies points of measurement on a map based on the position data 10c in the inference information 710 (FIG. 22) (S411). In other words, the inference distribution map generating device 2 converts the measurement point corresponding to the position data 10c in each inference information 710 to a position in a prescribed map for identifying display positions. FIG. 25 shows an inference distribution map generated from four samples of inference information 710. Measurement points of the inference information 710 are identified in the prescribed map with an “X”.

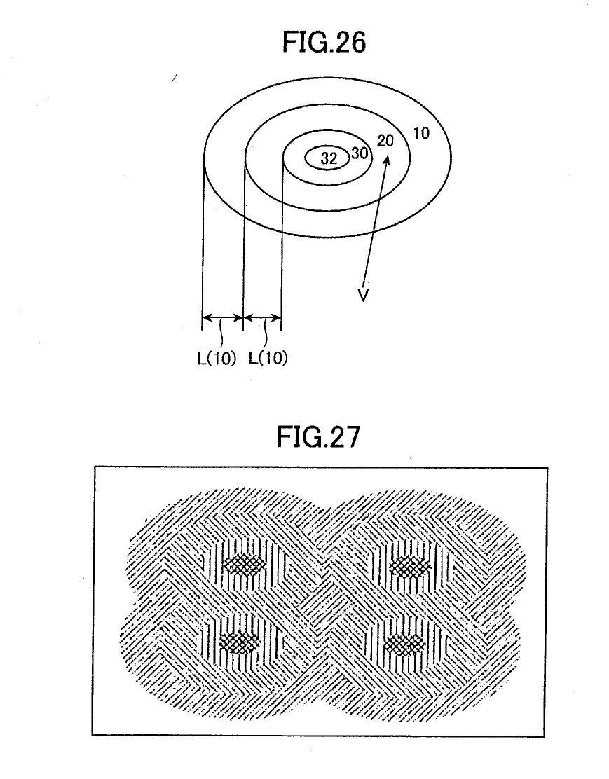

Next, the drawing range and drawing shape of the concentric circles (contour lines) around each measured value are identified based on the inference value 10a in each inference information 710, as shown in FIG. 26 (S412). In the preferred embodiment, the interval between each concentric circle is identical, and a region value V is set for each concentric circle. The region value V is set to the inference value 10a of the measurement point in the center circle and to values that decrease at regular intervals toward the outer concentric circles. In the example of FIG. 26, the inference value 10a of the measurement point is “32”. Region values that decrease by 10 at regular intervals L (10) are set in progressively outward concentric circles. In this way, the drawing range and drawing shape are identified in S412 for all of the measurement points. As a result, the drawing position and range of the concentric circles are identified for all measured values, as shown in FIG. 25.

Finally, the CPU 210 executes a process for drawing the distribution map based on the concentric contour lines (S413). Specifically, colored drawing is performed for coloring regions in concentric circles having the same regional value with the same color. The drawing process is performed for all regional values in order from the lowest regional value to the highest. The result is an inference distribution map color coded for each region of value, as shown in FIG. 27. By referring to the inference distribution map, it is possible to determine in which regions (areas) the plurality of users felt strong “excitement” and conversely in which regions (areas) the users did not feel “excitement”, and the like, for example.

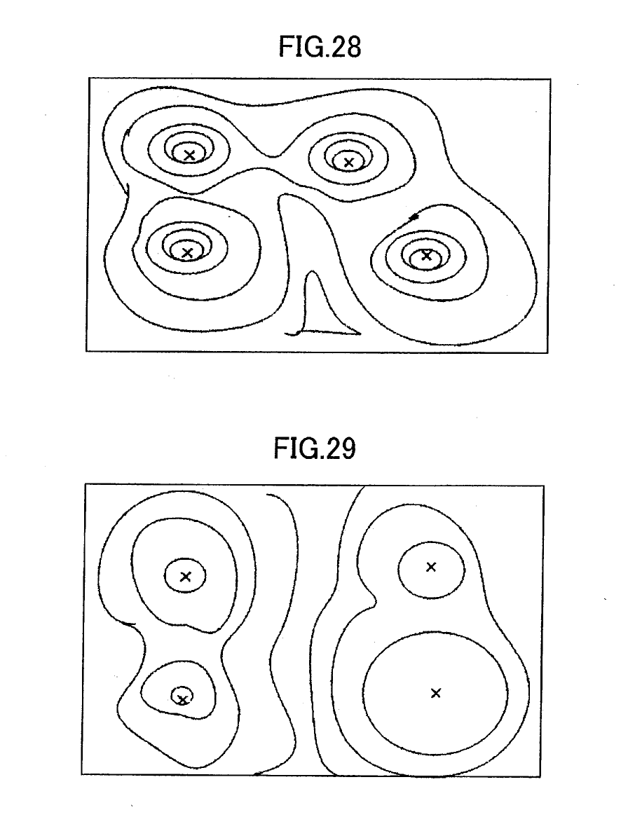

Instead of the inference distribution map described above, the CPU 210 may create the following type of inference distribution map in the inference distribution map drawing process (S402). First, the CPU 210 identifies measurement point based on the position data 10c in the inference information 710. Next, the CPU 210 sets the measured value for each measurement point to the respective inference value 10a in the inference information 710. Next, using the measured value at the measurement point as the innermost value, the CPU 210 displays contour lines based on the magnitude of the measured value. Hence, it is possible to create an inference distribution map based on the position data 10c, as shown in FIG. 28.

The CPU 210 may also create the following type of inference distribution map in the inference distribution map drawing process (S402). First, the CPU 210 identifies the measurement point based on the position data 10c in the inference information 710. Next, the CPU 210 finds the magnitude of temporal change in the inference value 10a at each measurement point based on the time data 10d in each inference information 710 as a temporal change value. Next, the CPU 210 displays contour lines based on the magnitude of the temporal change value at each measurement point. As a result, the CPU 210 can create an inference distribution map based on the position data 10c and time data 10d, as shown in FIG. 29.

If the inference information 710 includes user ID data, it is also possible to create a plurality of inference distribution maps, one for each user, or to create a single inference distribution map displaying data categorized by user.

In this way, the inference distribution map generating device 2 creates an inference distribution map for users in the inference distribution map generating process (FIG. 23). The inference distribution map can be created from a variety of perspectives, such as a perspective based on the inference value 10a, inference type 10b, position data 10c, time data 10d, or the like, according to the users objective or application and can be used in a variety of fields.

For example, in the event of an earthquake, typhoon, heavy snowfall, or other disaster, an inference distribution map can be created for the disaster region by mapping the inference information 710 on a map of the disaster region. By referring to this inference distribution map it could be possible to learn the distribution of the attitude, emotions, and the like of each user when the disaster occurred and to learn the psychological state of the victims. In a stadium, concert venue, or the like, the inference information 710 could be mapped over a seating chart to determine the distribution of each user's attitude, emotions, and the like during an event.

The inference distribution map generating system 700 according to the second embodiment described above can create inference distribution maps for the inference information 710, such as user's attitude, emotions, and the like, to learn the distribution of this inference information 710.

Next, a third embodiment of the present invention will be described while referring to the accompanying drawings. As in the first embodiment described above, an inference information creating device according to the third embodiment is a small portable terminal.

The inference information creating device 1 of the preferred embodiment generates inference information by inferring the attitude, emotions, and the like of users with an inference engine based on sensor measured data and user-inputted switch data and also executes a process based on characteristic data of the inference information. Parts and components in the structure of the third embodiment that are similar to those in the first and second embodiments have been designated with the same reference numerals to avoid duplicating description.

The structure of an inference information creating device 801 according to the third embodiment is basically the same as the inference information creating device 1 according to the first embodiment shown in FIG. 1. However, in the third embodiment, the input panel 181 is additionally provided with a characteristic-based process switch 156 indicated by a dotted line in FIG. 1 for executing a process according to specific characteristics. As in the first embodiment described above, the inference information creating device 801 creates inference information by inferring a user's attitude, emotions, and the like with an inference engine based on sensor data acquired from the body temperature sensor 182, perspiration sensor 183, and heart rate sensor 184, and executes a process based on characteristic data of the inference information.

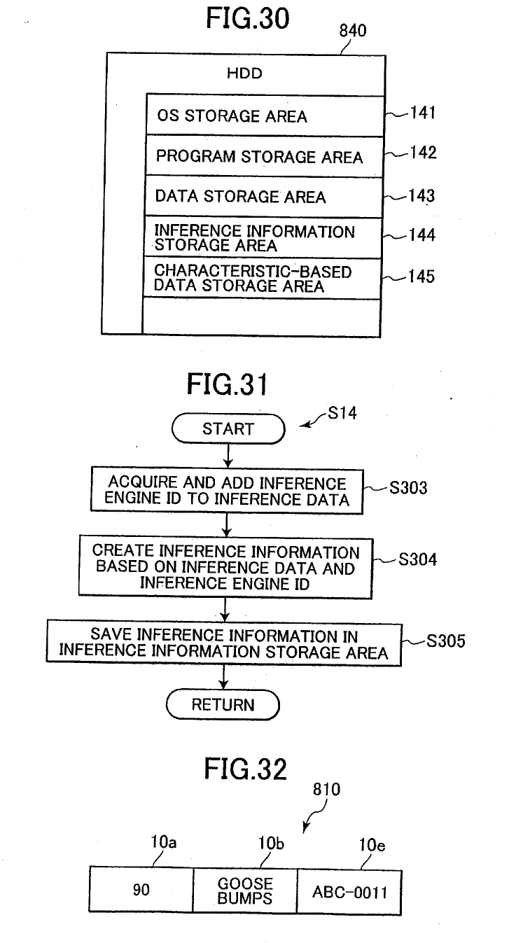

The computer 11 has an HDD 840 shown in FIG. 30. As with the HDD 140 of the first embodiment, the HDD 840 includes the OS storage area 141, program storage area 142, data storage area 143, and inference information storage area 144. In the third embodiment, the HDD 840 is additionally provided with a characteristic-based data storage area 145 for storing inference information processed by characteristic.

Further, each of the inference engines stored in the program storage area 142 holds an inference engine ID, which is a unique fixed identification number by which each inference engine can be uniquely identified. The inference engine ID is basically non-rewritable ID data.

Next, steps in a process executed by the inference information creating device 801 of the third embodiment will be described. As its main process, the inference information creating device 801 of the third embodiment executes an “inference information creating process” for creating data based on the user-inputted switch data and sensor measured values; and a “inference information characteristic-based process” for executing a process suited to the characteristics of the inference engine being used.

The “inference information creating process” of the third embodiment is identical to that of the first embodiment described in FIGS. 4A-17, excluding S14. S14 in the third embodiment is executed as shown in FIG. 31. Namely, the CPU 110 acquires an inference engine ID and creates inference information by appending the inference engine ID to the inference data created in the inference data creating process (S303). Since each inference engine stored in the HDD 840 holds an inference engine ID as described above, the CPU 110 references the inference engine set in S3, acquires the ID for that inference engine, and appends the ID to the inference data. Next, the CPU 110 creates inference information 810 based on the inference data and inference engine ID (S304). As shown in FIG. 32, the inference information 810 includes at least the inference value 10a, inference type 10b, and an inference engine ID 10e. The CPU 110 saves the inference information 810 generated or created in S304 in the inference information storage area 144 (FIG. 30) of the HDD 840 (S305).

By adding the inference engine ID 10e to the inference information 810 to indicate the source of the inference engine, the “inference information creating process” of the third embodiment described above can clarify the source of the inference engine to enhance the reliability of the inference information 810.

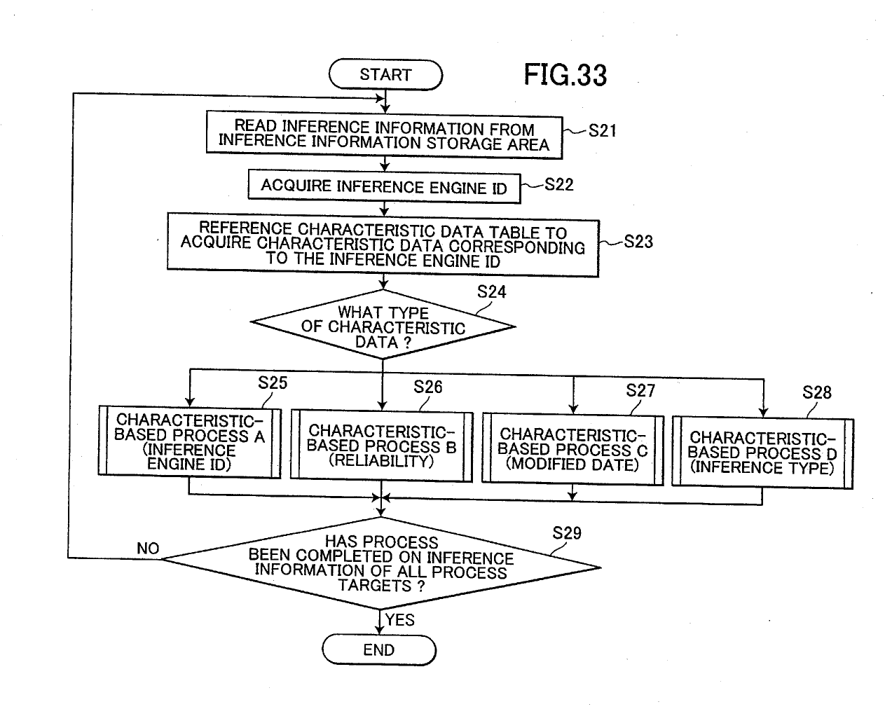

Next, the “inference information character-based process” will be described with reference to FIGS. 33 through 38. The inference information characteristic-based process described below is one example in which the user can create a report or the like based on inference information through a process performed by characteristic.

The process in the main flowchart (FIG. 33) of the inference information characteristic-based process begins when the user issues a command for the process by operating the process switch 156 in the input panel 181, or at prescribed intervals, or after the inference information 810 is stored in the inference information storage area 144 in S305. The timing at which this process is executed can be set arbitrarily by the user or the designer. However, in the preferred embodiment, this process begins when the user operates the process switch 156 in the input panel 181.

In the inference information characteristic-based process shown in FIG. 33, the CPU 110 reads the inference information 810 that is to be processed by characteristic from the inference information storage area 144 (FIG. 30) of the HDD 840 (S21). Here, the CPU 110 may read all of the inference information 810 saved in the inference information storage area 144 or only a portion of the inference information 810. The CPU 110 may also allow the user to select the inference information 810 entries to be read. Next, the CPU 110 acquires the inference engine ID 10e from the inference information 810 targeted for processing (S22). As described above, the inference information 810 includes the inference engine ID 10e (FIG. 32), which is unique identification data identifying the inference engine used in creating the inference information. The CPU 110 acquires this inference engine ID 10e from the inference information 810.

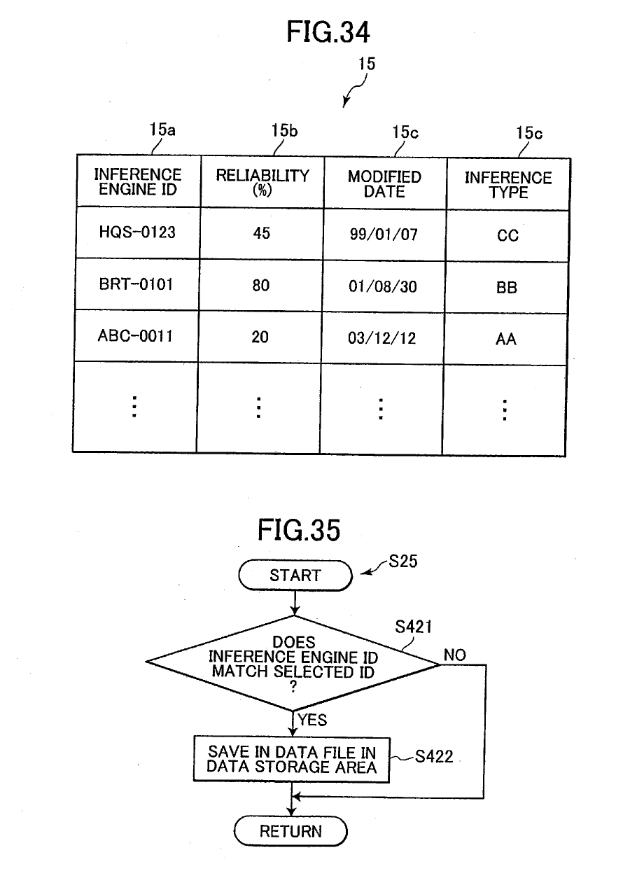

Next, the CPU 110 references a characteristic data table 15 to acquire characteristic information corresponding to the inference engine ID 10e (S23). As shown in FIG. 34, the characteristic data table 15 includes an inference engine ID 15a, reliability 15b, modified date 15c, and inference type 15d as data fields. These fields are defined and associated with each other in a table format. The reliability 15b indicates the level of accuracy of the inference engine, where a higher value indicates a greater capability for accurate inference. The modified date 15c indicates the most recent update date of the inference engine, a recent date indicating that the engine was created or modified recently. Accordingly, it is possible to learn characteristics of each inference engine from this table 15.

The inference type 15d indicates the type of inference method employed by the inference engine. For example, an inference engine having the inference type “AA” performs inferences by looking up measured values received from sensors in a lookup table (LUT) such as the inference definition table 13, inference definition table 113, and inference definition table 213 (FIGS. 8A-8C). An inference engine of inference type “BB” performs inferences by performing prescribed arithmetic calculations on measured values received from sensors. An inference engine of inference type “CC” performs inferences by processing the measured sensor values according to a prescribed procedure. An inference engine of inference type “DD” is a hybrid type that combines a plurality of techniques from inference methods “AA”, “BB”, and “CC”.

The characteristic data table 15 is a definition file providing properties of each inference engine. Accordingly, the latest definition file can be acquired from an external storage medium or network automatically or through a user operation, and the characteristic data table 15 can be regularly updated based on the latest definition file.

Therefore, in S23 the CPU 110 acquires the inference engine ID 15a, reliability 15b, modified date 15c, and inference type 15d as characteristic data by using the inference engine ID 10e in the inference information 810 as an index. For example, when the process target is the inference information 810 shown in FIG. 32, the CPU 110 uses the inference engine ID 10e “ABC-0011” as an index in the characteristic data table 15 to acquire the inference engine ID 15a of “ABC-0011”, the reliability 15b of “20”, the modified date 15c of “03/12/12”, and the inference type 15d of “AA” as the characteristic data.

Next, the CPU 110 determines which of the data fields is the subject of the characteristic-based process (S24) and selects a characteristic-based process based on the results of this determination. Definition data indicating which data field should be the subject of the process is preset in the HDD 840 or the like. However, the definition data can be set arbitrarily by the user or the designer and may be changed as is appropriate. For example, if the characteristic data is inference engine ID, then a characteristic-based process A (S25) is executed based on the inference engine ID 15a acquired in S23. Similarly, if the characteristic data is reliability, then a characteristic-based process B (S26) is executed based on the reliability 15b. If the characteristic data is modified date, then a characteristic-based process C (S27) is executed based on the modified date 15c. If the characteristic data is inference type, then a characteristic-based process D (S28) is executed based on the inference type 15d.

FIG. 35 shows the characteristic-based process A (process based on the inference engine ID). In this process, the CPU 110 determines whether the inference engine ID 15a matches ID of the preset inference engine (S421). The preset inference engine is set in the HDD 840 or the like. However, this inference engine may be arbitrarily set by the user or the designer and may be changed as appropriate. If the inference engine ID 15a matches the ID of the preset inference engine (S421: YES), then the CPU 110 saves the inference information 810 in a data file (not shown) provided in the data storage area 145 (FIG. 30) of the HDD 840 (S422). However, if the inference engine ID 15a does not match the ID of the preset inference engine (S421: NO), then the CPU 110 discards the inference information 810 and advances to S29 in FIG. 33.

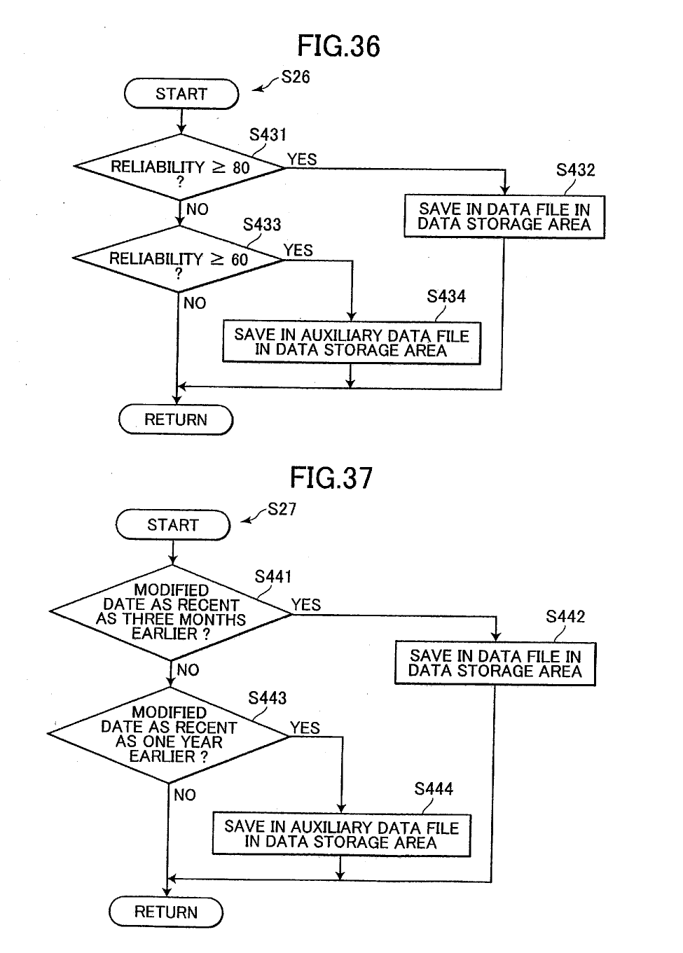

FIG. 36 shows the characteristic-based process B (process according to reliability). In this process, the CPU 110 determines whether the reliability 15b is greater than or equal to “80” (S431). If the reliability 15b is greater than or equal to “80” (S431: YES), then, as in S422, the CPU 110 saves the inference information 810 in a data file (not shown) in the data storage area 145 (S432). However, if the reliability 15b is less than “80” (S431: NO), then the CPU 110 determines whether the reliability 15b is greater than or equal to “60” (S433). If the reliability 15b is greater than or equal to “60” (S433: YES), then the CPU 110 saves the inference information 810 in an auxiliary data file (not shown) provided in the data storage area 145 (FIG. 30) of the HDD 840 (S434). However, if the reliability 15b is less than “60” (S433: NO), then the CPU 110 discards the inference information 810 and advances to S29 in FIG. 33. Through this process, the inference information creating device 801 can save the inference information 810 created by a highly reliable inference engine in a data file or can save the inference information 810 created by an inference engine with relatively high reliability in an auxiliary data file. Accordingly, the user can use the data file and auxiliary data file separately.

FIG. 37 shows the characteristic-based process C (process according to modified date). In this process, the CPU 110 determines whether the modified date 15c is greater than or equal to a numerical value indicating a date three months earlier (that is, whether the modified date 15c is identical to or more recent than a date three months earlier; S441). If the modified date 15c is identical to or more recent than a date three months earlier (S441: YES), then, as in S432, the CPU 110 saves the inference information 810 in a data file (not shown) provided in the data storage area 145 (FIG. 30; S442). However, if the modified date 15c is older than a date three months earlier (S441: NO), then the CPU 110 determines whether the modified date 15c is greater than or equal to (more recent than) a numerical value indicating a date one year earlier (S443). If the modified date 15c is identical to or more recent than a date one year earlier (S443: YES), then, as in S434, the CPU 110 saves the inference information 810 in the auxiliary data file provided in the data storage area 145 (FIG. 30; S444).

However, if the modified date 15c is older than a date one year earlier (S443: NO), then the CPU 110 discards the inference information 810 and advances to S29 in FIG. 33. Through this process, the inference information creating device 801 can save the inference information 810 created by a recently updated inference engine in the data file or can save the inference information 810 created by an inference engine that was updated relatively recently in the auxiliary data file. Accordingly, the user can use the data file and auxiliary data file for different purposes.

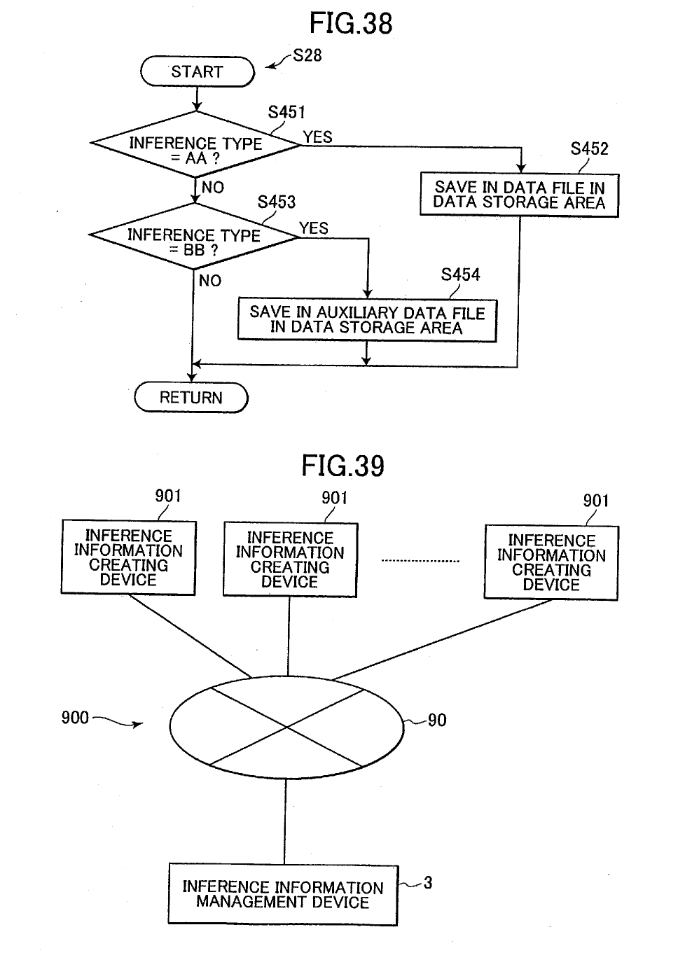

FIG. 38 shows the characteristic-based process D (process according to inference type). In this process, the CPU 110 determines whether the inference type 15d matches “AA” (S451). If the inference type 15d is “AA” (S451: YES), then, as in S432, the CPU 110 saves the inference information 810 in a data file (not shown) provided in the data storage area 145 (FIG. 30; S452). However, if the inference type 15d is not “AA” (S451: NO), then the CPU 110 determines whether the inference type 15d matches “BB” (S453). If the inference type 15d is “BB” (S453: YES), then, as in S434, the CPU 110 saves this inference information 810 in an auxiliary data file (not shown) provided in the data storage area 145 (FIG. 30; S454).

However, if the inference type 15d is not “BB” (S453: NO), then the CPU 110 discards the inference information 810 and advances to S29 in FIG. 33. Through this process, the inference information creating device 801 can save the inference information 810 created by an inference engine of inference type “AA” in the data file and can save the inference information 810 created by an inference engine of inference type “BB” in the auxiliary data file. Accordingly, the user can categorize the inference information 810 in the data file and auxiliary data file according to inference type.

In the characteristic-based processes (S25, S26, S27, and S28) shown in FIGS. 35 through 38, the inference information creating device 801 executes processes based on each of the different types of characteristic data, thereby enabling the user to obtain effective and convenient data for creating reports or the like based on the inference information 810. Since only the necessary data is obtained, these processes make it possible to effectively use the data.

For example, by performing characteristic-based processes for such characteristic data types as earthquakes, emotions, attitude, conditions, events, atmosphere, target objects, and target people, the psychological state of the users can be accurately learned for each type.

Next, as shown in FIG. 33, the CPU 110 determines whether the characteristic-based process has been performed on all inference information 810 targeted for the process that were read from the inference information storage area 144 (S29). If the process has not been executed for all inference information 810 targeted for processing (S29: NO), then the CPU 110 returns to S21 to perform the process on the remaining inference information 810. Hence, the process in S21-S29 is repeated until no unprocessed inference information 810 remains. When the process has been performed for all inference information 810 targeted for processing (S29: YES), then the process ends.

In the preferred embodiment, the characteristic-based processes described above (S25, S26, S27, and S28) are performed on the inference information 810, but the present invention is not limited to these processes. For example, instead of performing the characteristic-based processes (S25, S26, S27, and S28), it is possible to sort the inference information 810 into separate files, process and modify the inference information 810 in each file, and compile the results in a single document. By providing various processes in this way, the user or designer can arbitrarily set a suitable process. Further, in the preferred embodiment, the inference engines each have a unique inference engine ID 10e. However, such unique ID data may be provided in each inference mode (S7-S13 in FIG. 4B) instead. In this case, IDs for each of the inference modes (S7-S13) used for creating the inference information 810 are included in the inference information 810, and the characteristic-based processes can be executed based on characteristic data corresponding to the IDs.

In the “inference information characteristic-based process” described above, a process can be executed according to the type of characteristic to obtain effective and convenient data from the inference information 810 for subsequent use. Hence, this process further broadens the scope of application for the inference information 810.

Next, an inference information management system 900 according to a fourth embodiment of the present invention will be described with reference to FIGS. 39 through 42. The inference information management system 900 is configured of inference information creating devices that are small portable terminals, and an inference information management device configured of a fixed computer and connected to the inference information creating devices via a network.

In the inference information management system 900 of the preferred embodiment, a plurality of the inference information creating devices each generate inference information, and the inference information management device collects the inference information via the network and processes the inference information according to characteristics.

First, the structure of the inference information management system 900 will be described, wherein like parts and components to those in the first through third embodiments have been designated with the same reference numerals to avoid duplicating description. As shown in FIG. 39, the inference information management system 900 includes a plurality of inference information creating devices 901, each of which are connected to an inference information management device 3 via the network 90. The network 90 may be either wired or wireless, provided that an effective connection can be made with each terminal to exchange data.

As shown in FIG. 19, the inference information creating device 901 has the same structure as the inference information creating device 701 according to the second embodiment. The inference information management device 3 (FIG. 20) also has basically the same structure as the inference distribution map generating device 2 according to the second embodiment. However, the characteristic data table 15 described with reference to FIG. 34 is stored in a data storage area (not shown) of the HDD 240. Further, in the fourth embodiment the mouse 281 or keyboard 282 functions as the process switch 156 in the third embodiment. Unlike the third embodiment, the inference information creating device 901 of the fourth embodiment performs an “inference information creating process” for generating inference information based on user-inputted switch data and measured values from each sensor, and the inference information management device 3 performs the “inference information characteristic-based process” for executing a process based on characteristics of the inference engine that generated the inference information. The “inference information creating process” is identical to that described in FIGS. 4A-17 of the first embodiment, except that the process in S14 is performed as described below.

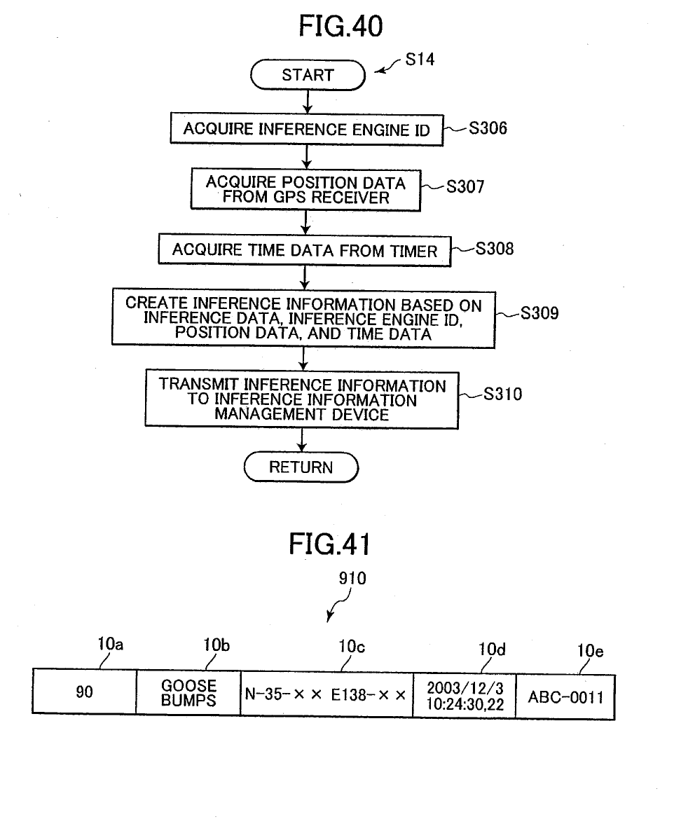

In the inference information outputting process (S14) shown in FIG. 40, the CPU 110 of the inference information creating device 901 first acquires the inference engine ID (S306). Next, the CPU 110 references the GPS receiver 185 to acquire position data indicating the current position (S307), and references the time-keeping device 190 to acquire time data indicating the current date and time (S308). Subsequently, the CPU 110 creates inference information 910 (FIG. 41) based on the inference data, the inference engine ID acquired in S306, the position data acquired in S307, and the time data acquired in S308 (S309). Next, the CPU 210 transmits the inference information created in S309 to the inference information management device 3 via the communication unit 170 and network 90 (S310).

The timing at which the inference information 910 is transmitted in S310 is not limited to when the inference information 910 is created. For example, the CPU 110 may save the inference information 910 created in S309 in the inference information storage area 144 (FIG. 30) of the HDD 140 and execute the transmission process of S310 either at prescribed intervals or when a command is received from the user.

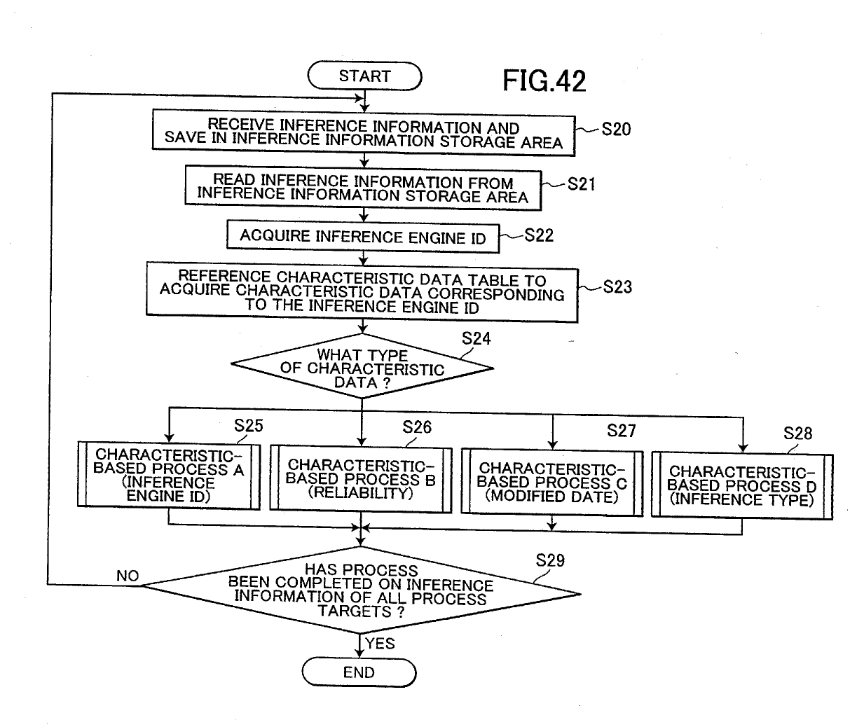

Next, the “inference information characteristic-based process” executed by the inference information management device 3 will be described with reference to FIG. 42. The “inference information characteristic-based process” according to the fourth embodiment is identical to that described in the third embodiment with reference to FIG. 33, except for the addition of S20. In the fourth embodiment, the inference information management device 3 initiates this process upon receiving the inference information 910 from the inference information creating device 901.

In the inference information characteristic-based process of the fourth embodiment shown in FIG. 42, the inference information management device 3 receives the inference information 910 transferred via the network 90 by the communication interface 291 and saves the inference information 910 in an inference information storage area (not shown) of the HDD 240 (S20). The remainder of the process is identical to the process described in FIG. 33 (S21-S29).

The process of S21-S29 need not be executed upon receiving the inference information 910 in S20. For example, after the inference information management device 3 saves the inference information 910 received in S20 in the inference information storage area of the HDD 240, the CPU 210 of the inference information management device 3 can subsequently execute the process of S21-S29 at regular intervals or upon receiving a command from the user. Further, the inference information 910 includes the position data 10c and time data 10d. Accordingly, the inference information management device 3 can generate a characteristic-based inference distribution map by performing the inference distribution map drawing process of the second embodiment based on the inference information 910 created in the characteristic-based process described above, and the position data 10c and time data 10d. In this way, the user can acquire a useful and accurate inference distribution map. In the fourth embodiment, it is also possible to perform only the characteristic-based process without adding the position data 10c and time data 10d to the inference information 910.

In the inference information management system 900 according to the fourth embodiment described above, the inference information management device 3 collects and manages the inference information 910 created on the inference information creating devices 901 and processes the inference information 910 based on characteristics. Therefore, the inference information creating device 901 that executes the “inference information creating process” can be configured independently of the inference information management device 3 that executes the “inference information characteristic-based process,” producing a inference information management system 900 with a greater degree of freedom and flexibility. The fourth embodiment also clarifies the source of the inference engine, thereby enhancing the reliability of the inference information 910 and broadening the scope of applications for the inference information 910.

Next, a fifth embodiment of the present invention will be described while referring to the accompanying drawings. An inference information creating device according to the fifth embodiment is also a small portable terminal. The inference information creating device of the fifth embodiment creates inference information from user-inputted switch data, various biological data measured by biological sensors, and various environmental data measured by environmental sensors. In the following description, like parts and components to those in the first through fourth embodiments have been designated with the same reference numerals to avoid duplicating description.

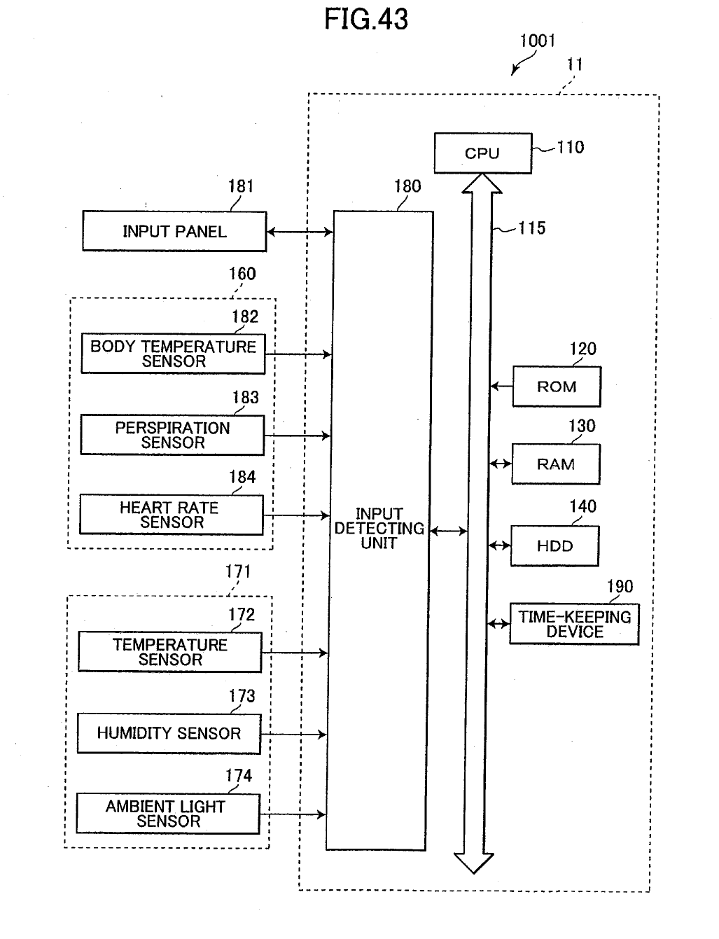

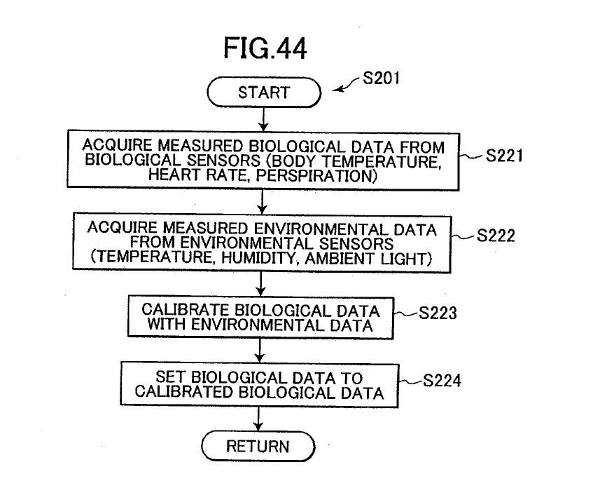

First, the structure of an inference information creating device 1001 according to the fifth embodiment will be described with reference to FIGS. 43 and 44. The inference information creating device 1001 according to the fifth embodiment has basically the same structure as the inference information creating device 1 according to the first embodiment shown in FIG. 1. However, the input detecting unit 180 in the fifth embodiment is connected to biological sensors 160 that measure various biological data on the user's physiological or physical reactions, and environmental sensors 171 that measure various environmental data related to external environmental factors that may influence the user or the sensors.

The biological sensors 160 are provided with the body temperature sensor 182 for measuring the user's body temperature, the perspiration sensor 183 for measuring the user's perspiration state, and the heart rate sensor 184 for measuring the user's heart rate, as described in the first embodiment.

The environmental sensors 171 include a temperature sensor 172 for measuring the temperature of the air, a humidity sensor 173 for measuring the humidity in the air, and an ambient light sensor 174 for measuring illuminance, that is the amount of luminous flux per unit area on a surface struck by light. The temperature sensor 172, humidity sensor 173, and ambient light sensor 174 may be arranged in any position and may employ any measuring method capable of effectively measuring the temperature, humidity, and ambient light around the user. Reading units of each sensor are preferably provided on the outer surface of the inference information creating device 1001. The temperature sensor 172 measures temperature within the range 0-50° C. The humidity sensor 173 measures humidity within the range 0-100% RH. The ambient light sensor 174 measures ambient light within the range 0-10,000 lux (lx).

When the inference information creating device 1001 is turned on and started up, each sensor in the biological sensors 160 and the environmental sensors 171 is controlled to perform periodic measurements automatically. Measured values from each sensor are saved in a prescribed storage area within each sensor. The CPU 110 of the inference information creating device 1001 acquires the most recent measured values from these prescribed storage areas via the input detecting unit 180. However, measured values acquired from each sensor via the input detecting unit 180 may be saved in the measured value storage area (not shown) is also provided in the HDD 140 for each sensor, and the CPU 110 may also reference this measured value storage area to acquire the most recent measured values.

Further, while not shown in the drawings, the input panel 181 is provided with the power reset switch 151, intention conveying switch 152, inference mode selection switch 153, and inference engine selection switch 154, as in the first embodiment. However, the input panel 181 is not strictly a necessary part of the construction and may be omitted. Further, the computer 11 may be remotely connected to an external input device via a USB cable, network, or other interface to enable the remote control thereof.

With this construction, the inference information creating device 1001 can create inference information by inferring the user's attitude and the like based on biological data received from the body temperature sensor 182, perspiration sensor 183, and heart rate sensor 184; and environmental data received from the temperature sensor 172, humidity sensor 173, and ambient light sensor 174.

In the preferred embodiment, the inference information creating device 1001 executes an “inference information creating process” for generating inference information based on user-inputted switch data and sensor-measured values. Here, the “inference information creating process” of the fifth embodiment is identical to the “inference information creating process” described in FIGS. 4A-17, except for the process of S201 in FIG. 7.

Next, the process of S201 in FIG. 7 executed by the inference information creating device 1001 of the fifth embodiment will be described with reference to FIG. 44. As shown in FIG. 44, the CPU 110 acquires measured biological values for body temperature, perspiration, and heart rate measured by the body temperature sensor 182, perspiration sensor 183, and heart rate sensor 184 (S221), and acquires the measured environmental values for temperature, humidity, and ambient light measured by the temperature sensor 172, humidity sensor 173, and ambient light sensor 174 (S222). Next, the CPU 110 calibrates each of the measured biological values acquired in S221 by the measured environmental values acquired in S222. The method of calibrating the measured values in S223 may be any of a variety of processes based on the measured biological and environmental values, an example of which is described below.

For example, for the measured body temperature value received from the body temperature sensor 182, the CPU 110 performs the arithmetic operation [measured body temperature after calibration]=[measured body temperature value]−[measured temperature value]×0.1 using the measured temperature value received from the temperature sensor 172 for calibrating the measured body temperature value. More specifically, if the [body temperature value] is “38.5° C.” and the [measured temperature value] is “20° C.”, then the [measured body temperature after calibration] is found to be “36.5° C.” from the above equation.

Further, the CPU 110 calibrates the measured perspiration value received from the perspiration sensor 183 using the measured humidity value by performing the arithmetic operation [measured perspiration value after calibration]=[measured perspiration value]×(100−[measured humidity value])/100. Specifically, if the [measured perspiration value] is “80% RH” and the [measured temperature value] is “50% RH”, then the [measured perspiration value] after calibration is found to be “40% RH” from the above equation.

Further, the CPU 110 identifies the measured heart rate value after calibration by referencing a heart rate calibration table (not shown) stored in the HDD 140 based on the measured heart rate value received from the heart rate sensor 184 and the measured ambient light value received from the ambient light sensor 174. The heart rate calibration table stores predefined [measured heart rate values after calibration] corresponding to combinations of [measured heart rate values] and [measured ambient light values]. Specifically, if the [measured heart rate value] is “150 BPM” and the [measured ambient light value] is “7,000 LX”, then the CPU 110 inference references the heart rate calibration table and identifies “100 BPM” as the value defined for the corresponding [measured heart rate value] after calibration.

Each of the post-calibration measured biological values is set as the measured biological values (S224). In other words, the [measured body temperature value after calibration], [measured perspiration after calibration], [measured heart rate after calibration] are set as the [measured body temperature value], [measured perspiration value], and [measured heart rate value]. In subsequent processes, inference data is created based on each of these post-calibration measured biological values.

As described above, the inference information creating device 1001 of the fifth embodiment can acquire measured biological values reduced by the effect of environmental factors by calibrating the measured biological values received from the biological sensors 160 with measured environmental values received from the environmental sensors 171. By creating the inference information 10 based on these post-calibration measured biological values, it is possible to accurately reflect the user's attitude, emotions, and the like.

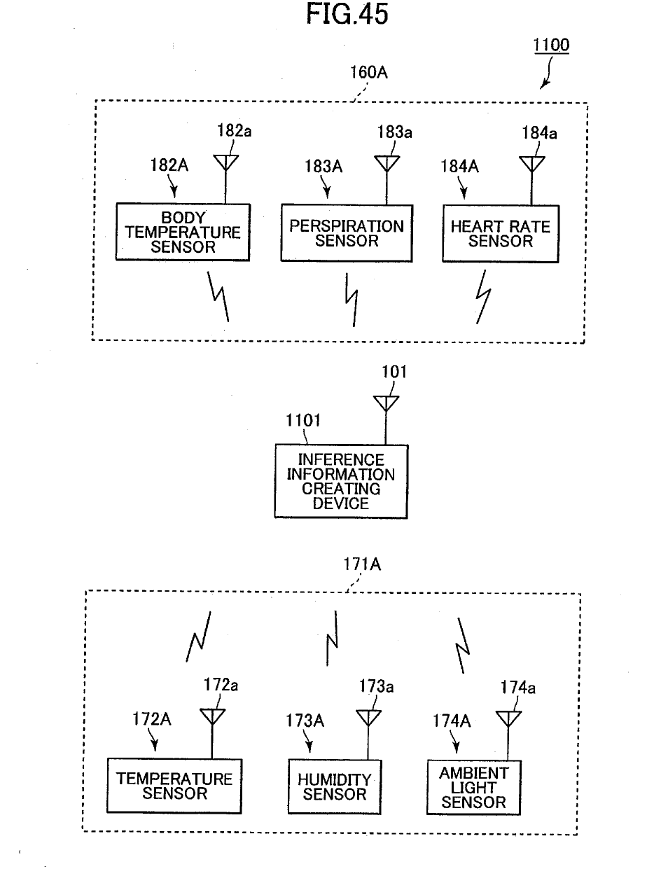

Next, an inference information creating system 1100 according to a sixth embodiment of the present invention will be described with reference to FIGS. 45 through 48. The inference information creating system 1100 provides wired or wireless connections between inference information creating devices, which are small portable terminals and a plurality of biological sensors for measuring the user's biological data and a plurality of environmental sensors for measuring environmental data around the user.

In the inference information creating system of the sixth embodiment, the inference information creating device collects biological values measured by the biological sensors and environmental values measured by the environmental sensors and creates inference information based on these measured values. In the following description like parts and components to those in the first through fifth embodiments have been designated with the same reference numerals to avoid duplicating description.

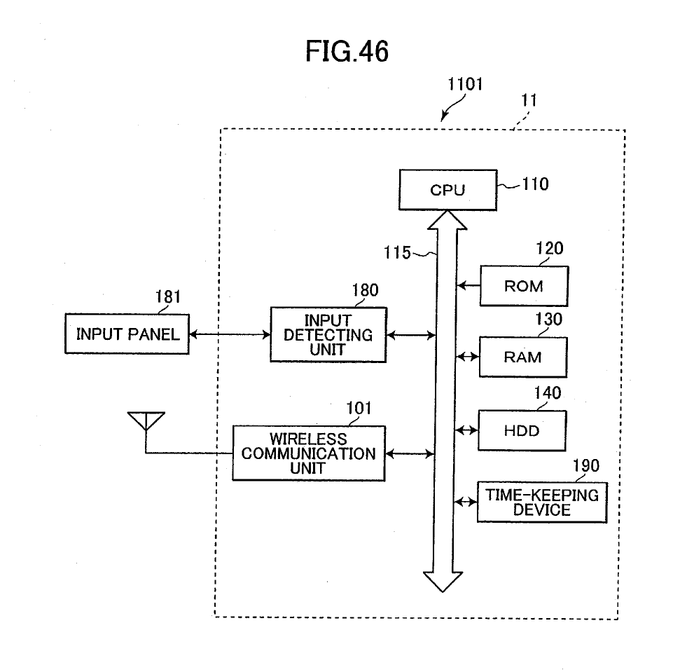

First, the structure of the inference information creating system 1100 will be described. As shown in FIG. 45, the inference information creating system 1100 includes an inference information creating device 1101, biological sensors 160A, and environmental sensors 171A. As shown in FIG. 46, the inference information creating device 1101 has an identical structure to the inference information creating device 1001 according to the fifth embodiment, except that the inference information creating device 1101 is not provided with the biological sensors 160 and environmental sensors 171, but further includes a wireless communication unit 101 that enables the computer 11 to perform short-range wireless communications.

The biological sensors 160A are independent of the inference information creating device 1101 and are not directly connected to the input detecting unit 180 of the inference information creating device 1101. The biological sensors 160A include a body temperature sensor 182A, a perspiration sensor 183A, and a heart rate sensor 184A. Each sensor has a corresponding wireless communication unit 182a, 183a, and 184a for performing short-range wireless communications between the wireless communication unit 101 provided in the inference information creating device 1101. Hence, the inference information creating device 1101 can be wirelessly connected with each sensor.

Similarly, the environmental sensors 171A are independent of the inference information creating device 1101 and are not directly connected to the input detecting unit 180 in the inference information creating device 1101. The environmental sensors 171A include a temperature sensor 172A, a humidity sensor 173A, and an ambient light sensor 174A. Each sensor includes a corresponding wireless communication unit 172a, 173a, and 174a, enabling the sensors to connect with the inference information creating device 1101 through short-range wireless communications. In this way, the inference information creating device 1101 according to the sixth embodiment is configured to acquire the various measured values from the biological sensors 160A and the environmental sensors 171A provided externally.

While the inference information creating device 1101 is connected to each of the sensors through short-range wireless communications in the sixth embodiment, the sensors and the inference information creating device 1101 may be connected wirelessly according to a wireless method based on the Bluetooth (registered trademark) or IEEE 802.11 standards or may be connected with wires, provided that an effective connection can be established between the sensors and the inference information creating device 1101. Each of the sensors provided external to the inference information creating device 1101 has a unique sensing function for the target of measurement (temperature, humidity, and the like).

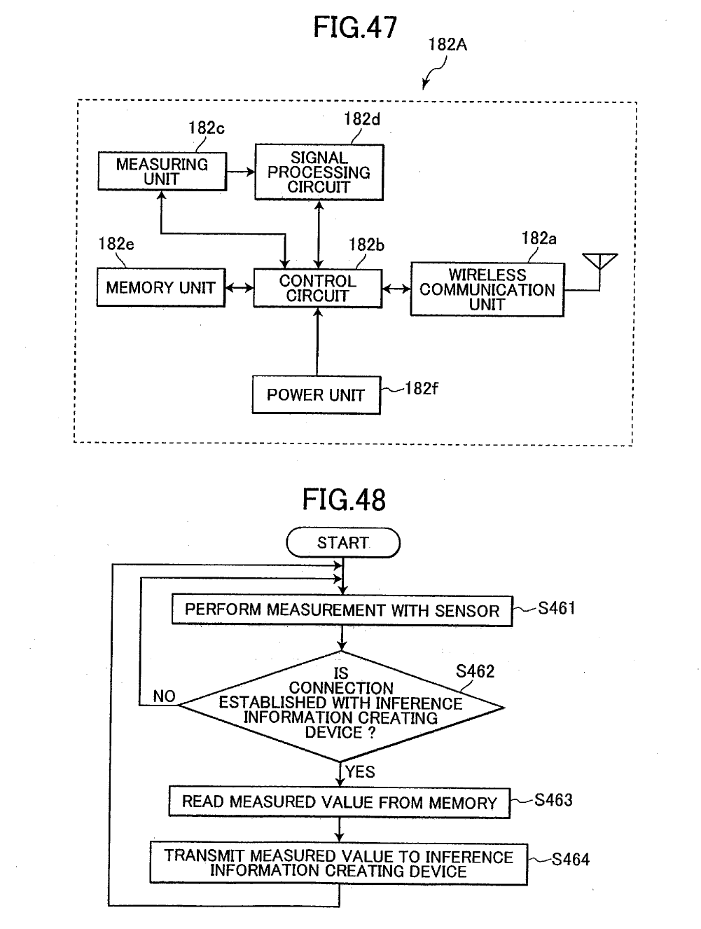

As shown in FIG. 47, the body temperature sensor 182A includes a control circuit 182b, a measuring unit 182c, a signal processing circuit 182d, a memory unit 182e, and a power unit 182f. The measuring unit 182c is provided in contact with the user's skin for measuring body temperature and has an identical structure to the body temperature sensor 182 of the first through fifth embodiments. The signal processing circuit 182d performs amplification, filtering, or other process on data read from the measuring unit 182c. The memory unit 182e stores the latest measured body temperature value processed by the signal processing circuit 182d. The power unit 182f supplies power to each component. The control circuit 182b functions as the main unit of the sensor and is connected to each component for controlling the same. The wireless communication unit 182a is also connected to the control circuit 182b and functions to transmit the measured body temperature values stored in the memory unit 182e to the inference information creating device 1101 through wireless communications. The perspiration sensor 183A, heart rate sensor 184A, temperature sensor 172A, humidity sensor 173A, and ambient light sensor 174A all have basically the same structure as the body temperature sensor 182A.

FIG. 48 is a main flowchart illustrating steps in a measurement value transmission process. First, a process executed by each sensor will be described. Each sensor measures biological or environmental data and executes a measurement value transmission process to transmit the measured value to the inference information creating device 1101. In the preferred embodiment this process begins when each sensor starts up.

In the measurement value transmission process shown in FIG. 48, each sensor measures the biological or environmental data (S461). In the case of the body temperature sensor 182A shown in FIG. 47, the control circuit 182b controls the measuring unit 182c to periodically measure the user's body temperature. Next, the signal processing circuit 182d performs a prescribed signal process on the data read with the measuring unit 182c. The processed data is stored in the memory unit 182e as a measured body temperature value. As the process in S461 is executed at prescribed intervals, each sensor always stores the latest measured value.

Next, the body temperature sensor 182A determines whether a connection is established between the wireless communication unit 182a and the inference information creating device 1101 (S462). If a connection is established with the inference information creating device 1101 (S462: YES), then the control circuit 182b reads the measured value from the memory unit 182e (S463) and the wireless communication unit 182a transmits the measured value to the inference information creating device 1101 (S464). However, if no connection is established with the inference information creating device 1101 (S462: NO), then the body temperature sensor 182A returns to S461. When the body temperature sensor 182A performs wireless communications with the inference information creating device 1101, the wireless communication unit 182a transmits the most recent measured body temperature value stored in the memory unit 182e to the inference information creating device 1101. The other sensors similarly transmit the most recent measured values via the corresponding wireless communication units to the inference information creating device 1101.

In the meantime, the inference information creating device 1001 executes an “inference information creating process” for generating inference information based on user-inputted switch data and sensor-measured values. Here, the “inference information creating process” of the sixth embodiment is identical to the “inference information creating process” described in FIGS. 4A-17, except for the process of S201 in FIG. 7. The inference information creating device 1101 performs the process of S201 described in the fifth embodiment with reference to FIG. 44. Here, the inference information creating device 1101 saves the most recent measured values from each sensor received via the wireless communication unit 101 in a measured value storage area (not shown) provided in the HDD 140 of the inference information creating device 1101 for each sensor. Accordingly, the inference information creating device 1101 can acquire the most recent measured values by referencing the measured value storage area when executing the processes of S221 and S222.

The measurement value transmission process shown in FIG. 48 is merely one example. For example, the inference information creating device 1101 may transmit a prescribed request signal to each sensor, and each sensor may transmit the latest measured value to the inference information creating device 1101 in response to the request signal. In this way, the inference information creating system 1100 can be configured with the inference information creating device 1101 capable of acquiring the latest measured values. In other words, any technique known in the art may be applied, provided that the inference information creating device 1101 can effectively acquire measured data from each sensor.

As described above, the inference information creating system 1100 according to the sixth embodiment collects data measured by the biological sensors 160A and environmental sensors 171A provided externally in the inference information creating device 1101 and creates inference information 10 (FIG. 17) based on this data. Hence, it is not necessary to provide the biological sensors 160A and environmental sensors 171A in the inference information creating device 1101 or to provide a direct connection therebetween, thereby achieving a lighter and more compact inference information creating device 1101. Further, since each sensor in the biological sensors 160A and environmental sensors 171A is configured independently of the inference information creating device 1101, the inference information creating system 1100 can have a freer and more flexible structure.

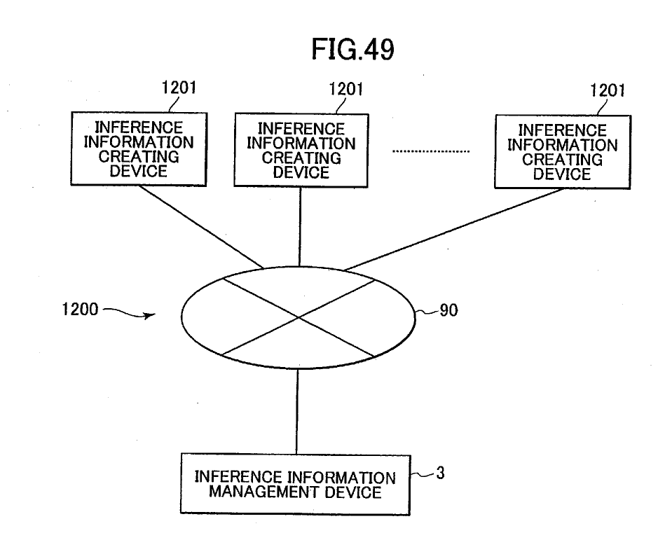

Next, an inference information management system 1200 according to a seventh embodiment of the present invention will be described with reference to FIGS. 49 and 52. The inference information management system 1200 includes inference information creating devices, which are small portable terminals, and an inference information management system, which is a fixed computer. The inference information creating devices are connected to the inference information management device via a network.

In the inference information management system of the seventh embodiment, the inference information management device collects inference information created on each of a plurality of inference information creating devices via the network and manages all of the inference information. Like parts and components in the first through sixth embodiments have been designated with the same reference numerals to avoid duplicating description.

First, the structure of the inference information management system 1200 according to the seventh embodiment will be described. As shown in FIG. 49, the inference information management system 1200 includes a plurality of inference information creating devices 1201 that are each connected to the inference information management device 3 via the network 90. The network 90 may be either a wired or wireless network provided that each terminal can be effectively connected to the inference information management device 3 for exchanging data.

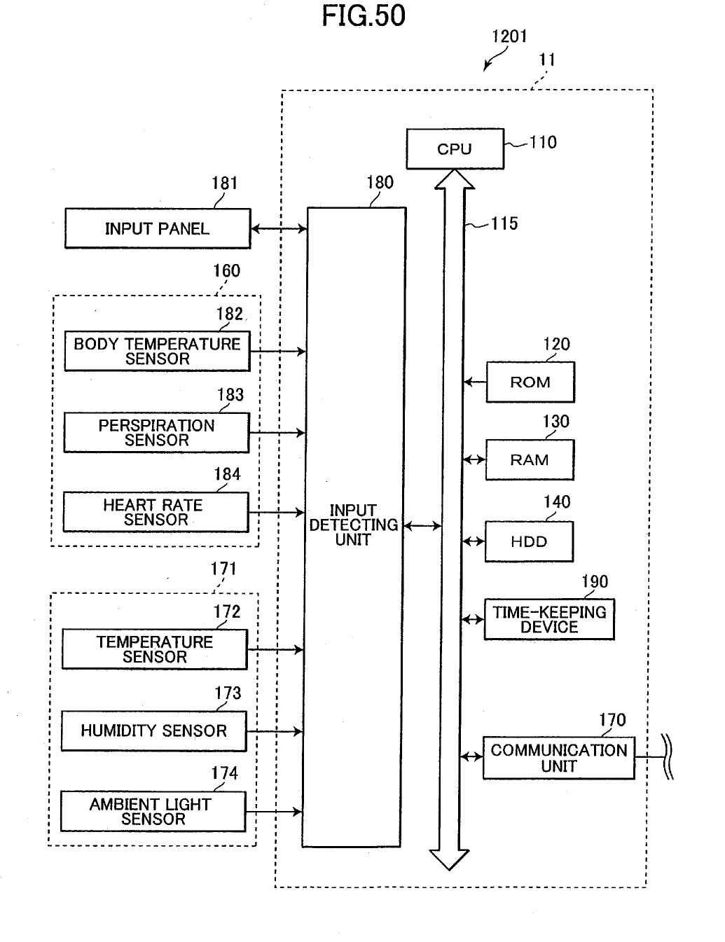

As shown in FIG. 50, each of the inference information creating devices 1201 has the same structure as the device of the fifth embodiment (FIG. 43), except that the inference information creating device 1201 is additionally provided with the communication unit 170 for connecting with the external network 90. The inference information creating device 1101 according to the sixth embodiment (FIG. 46) can function as the inference information creating device 1201 of the seventh embodiment if provided with the communication unit 170.

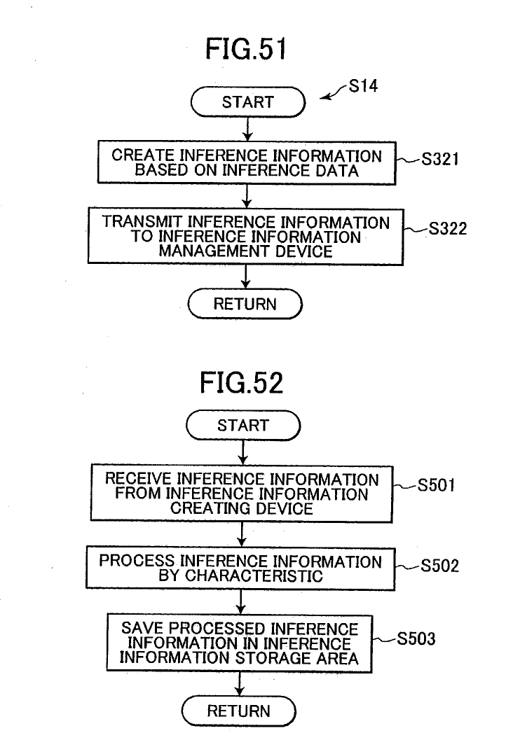

In the inference information management system 1200 of the seventh embodiment, the inference information creating device 1201 performs a “inference information creating process,” while the inference information management device 3 performs a “inference information management process.” The inference information creating process is identical to the process described in the first embodiment with reference to FIGS. 4A-17, except that S201 is performed as described in the fifth embodiment with reference to FIG. 44 and S14 is performed as described below with reference to FIG. 51.

In the inference information outputting process (S14) shown in FIG. 51, the CPU 110 of the inference information creating device 1201 creates the inference information 10 (FIG. 17) based on inference data generated in one of the inference data creating processes (one of S7-S13), as in S301 of FIG. 16 (S321). Next, the CPU 110 transmits the inference information 10 created in S321 to the inference information management device 3 via a communication unit 170 and network 90 (S322).

The timing at which the transmission process of S322 is executed is not limited to when the inference information 10 is created. For example, the CPU 110 may save the inference information 10 generated in S321 in the inference information storage area 144 of the HDD 140 (FIG. 3) and execute the transmission process of S322 at regular intervals or upon receiving a command from the user.

Next, the inference information management process performed by the inference information management device 3 (FIG. 20) will be described. The inference information management device 3 executes the inference information management process for receiving and managing inference information 10 transmitted from the inference information creating devices 1201. In the preferred embodiment, the inference information management device 3 begins this process upon receiving the inference information 10 from the inference information creating device 1201.

In the inference information management process shown in FIG. 52, the CPU 210 of the inference information management device 3 receives inference information 10 transmitted via the network 90 in the communication interface 291 (S501). The CPU 210 processes the inference information 10 received in S501 based on characteristics (S502). Specifically, the CPU 210 performs a process based on a unique characteristic of the inference information 10, such as the user, source, creation date and time, and inference technique. For example, the CPU 210 may sort and process the inference information 10 according to user or may sort each of the inference information 10 in order of the creation date and time. The details of the process performed in S502 may be set arbitrarily by the user or designer. Subsequently, the CPU 210 saves the processed inference information 10 in an inference information storage area (not shown) of the HDD 240 (S503).

The timing for executing the process in S502 is not limited to when the inference information 10 is received in S501. For example, the CPU 210 may first save the inference information 10 received in S501 in the inference information storage area of the HDD 240 and may subsequently execute the process in S502 at regular intervals or upon receiving a command from the user. Further, the CPU 210 need not execute the process in S502 if there is no need to process the inference information 10 according to characteristics.

In the inference information management system 1200 of the seventh embodiment described above, the inference information creating devices 1201 create the inference information 10 and the inference information management device 3 collects and manages the inference information 10. Therefore, the inference information creating device 1201 for forming the inference information 10 can be configured independently of the inference information management device 3 for saving and managing the inference information 10, thereby achieving a inference information management system 1200 with a more flexible structure.

It should be apparent that the present invention is not limited to the first through seventh embodiments described above and that many modifications and variations may be made therein. For example, examples of user-related inference information in the preferred embodiments are “excitement,” “sadness,” and “joy.” However, in addition to the user's attitude and emotions, inference information may be data on abstract concepts (also called context), such as atmosphere and importance, that indicate context, conditions, and the like of an event and that cannot be learned simply from facts and evidence. Accordingly, it is possible to generate inference information on “anger,” “enjoyment,” “gaiety,” “busyness,” and to provide the inference definition table 13 corresponding to each type of inference information. For example, if it is desirable to create inference information based on a user's “enjoyment,” an inference definition table should be created for “enjoyment.”

Further, tables for desired inference targets may be preset in an inference definition table by the user or designer. It is possible to provide a plurality of tables corresponding to a plurality of inference targets and to automatically select the appropriate table in the inference execution process based on measured sensor values of S11 (FIG. 7).

Further, in the process for initializing sensor values (FIG. 5) sampled values are measured and averaged to calculate a reference value. However, it is possible to acquire time series data for a sampled value and to calculate a reference value based on changes in the time series. The reference values may also be calculated after discarding abnormal sampled values. Further, in the comparison processes (S203, S205, and S207) in the inference execution process based on measured sensor values (FIG. 7), it is possible to provide a change threshold ε for each sensor and to perform comparisons with measured values from each sensor using a calibration value derived by calibrating the threshold value with the change threshold ε. For example, the change threshold ε may be set to approximately 5% of the threshold value to serve as a range of error tolerance. Further, in the preferred embodiments, measured sensor values are compared to the threshold values to determine a change in status. However, a change in status may also be determined by subtracting a prescribed reference value from the measured sensor value to find an amount of increase and by determining whether the amount of increase is greater than or smaller than a threshold value.

Further, data inputted by the user is not restricted to switch data inputted via the intention conveying switch 152, but may be text and commands inputted from an input panel or keyboard, menu selections inputted with the mouse, or any other method that allows the user to input prescribed data by the user's own volition.

While the inference information creating device 1 has three sensors, including the body temperature sensor 182, perspiration sensor 183, and heart rate sensor 184, it is sufficient for the inference information creating device 1 to have at least one of these sensors. Further, it should be apparent that the measured values from these sensors are not limited to body temperature, perspiration, and heart rate. For example, it is possible to measure trembling, brain waves, breathing, acceleration, inclination, biorhythms, and the like from the user. Further, the sensors (the body temperature sensor 182, perspiration sensor 183, and heart rate sensor 184) and the input panel 181 need not be configured as a unit in the inference information creating device 1, but may be connected remotely to the input detecting unit 180 via a USB cable, a network, or other interface, provided that the inference information creating device 1 can acquire measured values and inputted data effectively.

In the inference distribution map generating system according to the second embodiment, the inference information creating device 701 acquires position data using the GPS receiver 185. However, such position data may be acquired by another method, provided that the current position can be identified effectively. For example, the inference information creating device 701 may be equipped with an interrogator of an RFID system (RFID tag reader) for issuing a prescribed request and acquiring position data from a nearby transponder (RFID tag). Further, the inference information creating device 701 may be provided with an ultrasonic transceiver. The transceiver can emit prescribed waves toward a reference object of known position, calculate a time difference in the reciprocated waves upon receiving reflected waves from the reference object to find a difference with the reference position, and can acquire position data for the current position based on the difference.

Further, the inference distribution map generating system may be provided with a plurality of the inference distribution map generating devices 2. The inference distribution map generating device 2 may also be configured integrally with the inference information creating device 701. Alternatively, the system may be provided with a single inference information creating device 701. Further, the inference distribution map generating device 2 need not be constructed with the display 261, microphone 271, speaker 272, mouse 281, and keyboard 282, but may be remotely connected to an external display device, microphone, speaker, and the like via USB cables, a network, or other interface and may control these devices remotely.

In the third and fourth embodiments described above, the inference engine ID 15a, reliability 15b, modified date 15c, and inference type 15d are defined in the characteristic data table 15 as characteristic data for inference engines. However, the characteristic data is not limited to these fields. For example, the user or designer can arbitrarily define various characteristics of the inference engine, such as the manufacturer, version data, and inference method. Further, the inference engine may be implemented in software (as a computer program) or in hardware, such as an electric circuit or device. Further, while the characteristic-based process can be performed on all characteristic data defined in the characteristic data table 15 in the preferred embodiments, it should be possible to perform this process on at least one or more fields in the defined characteristic data.

If the characteristic data is determined to be unsuitable for the subsequent process on the stored inference information due to the reliability or the modified date, it is possible to reacquire inference information using another inference engine or to calibrate the data using a suitable calibration value to convert the inference information to a suitable value.

In the inference execution process shown in FIG. 7 according to the fifth through seventh embodiments, measured biological values are calibrated with measured environmental values according to the measured value setting process (S201) shown in FIG. 44, and inference data is generated based on the post-calibration biological values. However, another method may be applied, provided that the method ultimately generates inference information that is less affected by environmental factors. For example, it is possible to create inference data and inference information based on measured biological values and to calibrate the inference data and inference information based on measured environmental values.

In the measured value setting process shown in FIG. 44, the effects of environmental factors are removed from the measured biological values (S223) by calibrating measured biological values received from the biological sensors 160 with the measured environmental values from the environmental sensors 171, but the measured values may be set according to another method, provided the method can reduce the effects of environmental factors. For example, it is possible to provide a table that defines post-calibration biological values corresponding to combinations of measured biological values and measured environmental values and to acquire the post-calibration biological values by referencing the table.

It should be apparent that the measured biological values from the biological sensors 160 are not limited to body temperature, perspiration, and heart rate. For example, it is possible to measure trembling, brain waves, breathing, acceleration, inclination, biorhythms, and the like from the user. It should also be apparent that the measured environmental values received from the environmental sensors 171 are not limited to temperature, humidity, and ambient light. For example, it is possible to measure noise, atmospheric pressure, wind velocity, seismic intensity, and other environmental factors.

Further, it should be apparent that the biological sensors 160 and the environmental sensors 171 may be arbitrarily provided with one or a plurality of sensors.

The inference information management device 3 shown in FIG. 20 according to the fourth or seventh embodiment need not be configured of the display 261, microphone 271, speaker 272, mouse 281, and keyboard 282. Therefore, the inference information management device 3 may be remotely connected to an external display device, microphone, speaker, and the like via USB cables, a network, or other interface and may control these components remotely.

The inference information management system 900 or 1200 according to either the fourth or seventh embodiment may include a plurality of the inference information management devices 3. Further, the inference information management device 3 may be configured integrally with the inference information creating device 901 or 1201. Further, the system may be provided with only a single inference information creating device 901 or 1201. As a variation of the preferred embodiments described above, it is possible to provide an inference information creating device comprising a measured value acquiring unit, an inference information creating unit, an ID data adding unit, and an inference information outputting unit. The measured value acquiring unit acquires measured values from at least one sensor. The inference information creating unit creates inference data based on the measured values acquired by the measured value acquiring unit, the inference data being an index value different from the measured value. The ID data adding unit adds ID data that is unique to the inference information creating unit to the inference data. The inference information outputting unit outputs inference information including the inference data to which the ID data is added.

With this construction, the inference information creating device creates inference data as an index value different from the measured values based on the measured values acquired from each sensor and outputs inference information including the inference data to which the unique ID data was added. Accordingly, the inference information creating device can clarify the source of the inference information creating unit and enhance the reliability of the inference information generated based on measured data received from each sensor.

It is preferable that the inference information creating device further comprises a characteristic data table and a characteristic data acquiring unit. The characteristic data table stores correlation between ID data of the inference information creating unit and characteristic data indicating characteristics of the inference information creating unit. The characteristic data acquiring unit acquires characteristic data from the characteristic data table corresponding to the ID data included in inference information outputted by the inference information outputting unit.

With this construction, the inference information creating device comprises the characteristic data table storing correlation between the ID data for the inference information creating unit and the characteristic data indicating characteristics of the inference information creating unit and acquires characteristic data from the characteristic data table for the inference information creating unit that created the inference information. Therefore, it is possible to learn the source and features of the inference information creating unit.

In addition to the structure of the inference information creating device described above, it is also preferable that the characteristic data include at least one of reliability, modified date, and inference type of the inference information creating unit.

By including the reliability, modified date, and inference type of the inference information creating unit in the characteristic data, it is possible to learn the source and features of the inference information creating unit.

In addition to the structure of the inference information creating device described above, it is also preferable that the device further comprise a process procedure selecting unit, and an inference information processing unit. The process procedure selecting unit comprises at least one process procedure that can be executed on inference information and selects one of a plurality of process procedures based on characteristic data acquired by the characteristic data acquiring unit. The inference information processing unit processes inference information outputted by the inference information outputting unit based on the process procedure selected by the process procedure selecting unit.

With this construction, the inference information creating device selects one of a plurality of process procedures based on characteristic data and executes a process according to the selected process procedure. Accordingly, the device executes a process suited to the characteristics of the inference information, thereby expanding the scope of applications for the inference information.

The inference information management system includes inference information creating devices that generates inference information on the user based on measured values acquired from at least one sensor; and an inference information management device that manages the inference information created by the inference information creating devices, wherein the inference information creating devices are connected to the inference information management device via a network. The inference information creating device comprises a measured value acquiring unit that acquires measured values from the sensors; an inference data creating unit that generates inference data as an index value different from the measured values based on the measured values acquired by the measured value acquiring unit; an ID data adding unit that adds ID data unique to the inference information creating unit to the inference data; and an inference information outputting unit that outputs inference information including the inference data to which the ID data has been added. The inference information management device comprises an inference information acquiring unit that acquires inference information outputted from an inference information creating device via a network; an inference information storing unit that stores data acquired by the inference information acquiring unit; a characteristic data table storing correlation between ID data for the inference information creating unit and characteristic data indicating a feature of the inference information creating unit; and a characteristic data acquiring unit that acquires characteristic data from the characteristic data table corresponding to the ID data included in inference information outputted by the inference information outputting unit.

With this construction, the inference information management device collects inference information from the inference information creating devices that create inference information on the user and acquires characteristic data based on ID data included in the inference information. Hence, the system can clarify the source of the inference information creating unit and can enhance the reliability of the inference information generated based on measured data acquired from the sensors.

In addition to the structure of the inference information management system described above, it is preferable that the characteristic data include at least one of reliability, modified date, and inference type of the inference information creating unit.

Since the characteristic data includes the reliability, modified date, and inference type of the inference information creating unit, the system having this construction can learn the source and features of the inference information creating unit.

In addition to the structure described above, it is preferable that the inference information management device of the inference information management system comprise at least one process procedure that processes inference information; a process procedure selecting unit that selects one of the plurality of process procedures based on the characteristic data acquired by the characteristic data acquiring unit; and an inference information processing unit that processes the inference information outputted by the inference information outputting unit based on the process procedure selected by the process procedure selecting unit.

With this construction, the inference information management device can select one of a plurality of process procedures based on characteristic data and perform a process according to the process procedure. Hence, it is possible to expand the scope of applications for inference information by executing a process suited to the characteristics of the inference information.

In addition to the structure of the inference information management system described above, it is preferable that the inference information outputting unit further comprise a first communication interfacing unit that performs data communications with the inference information management device through a wired or wireless connection, and that the inference information acquiring unit further comprise a second communication interfacing unit that exchanges data with the inference information creating devices through a wired or wireless connection.

By providing the inference information creating devices and inference information management device with an interfacing unit for exchanging data, remotely provided inference information creating devices and the inference information management device can be connected via a network.

It is also possible to provide an inference information creating program that instructs a computer to function as a measurement value acquiring unit that acquires measurement values from at least one sensor; an inference information creating unit that generats inference data as an index value different from the measurement values based on measurement values acquired by the measured value acquiring unit; an ID data adding unit that adds ID data unique to the inference information creating unit to inference data; and an inference information outputting unit that outputs inference information including the inference data to which the ID data has been added.

A program with this configuration creates inference data as an index value different from the measured values based on measured values acquired from the sensors and outputs inference information including the inference data to which ID data unique to the inference information creating unit has been added. Accordingly, this program can clarify the source of the inference information creating unit and enhance the reliability of inference information created based on measured data received from the sensors.

It is also possible to provide an inference information creating device comprising a biological data acquiring unit, an environmental data acquiring unit, an inference information creating unit, and an inference information outputting unit. Biological sensors measure a user's biological data. The biological data acquiring unit acquires the biological data from the sensors. The environmental data acquiring unit acquires environmental data from environmental sensors measuring environmental data. The inference information creating unit creates inference data as an index value different from the biological data and environmental data based on biological data acquired by the biological data acquiring unit and environmental data acquired by the environmental data acquiring unit. The inference information outputting unit outputs inference information including the inference data created by the inference information creating unit.

The inference information creating device having this construction creates inference data as an index value different from biological data and environmental data based on biological data acquired from biological sensors and environmental data acquired from environmental sensors. Accordingly, the device can generate inference information based on biological data from biological sensors and environmental data from environmental sensors that is highly accurate information with less impact from environmental factors.

Here, it is preferable that the inference information creating unit calibrate the biological data based on the environmental data and create inference data based on the post-calibration biological data.

With this construction, the inference information creating unit calibrates the biological data according to environmental data and creates inference data based on the post-calibration biological data. By calibrating the biological data based on the environmental data, it is possible to generate highly precise inference information that has less influence from environmental factors, even when the user or the biological sensors are affected by such environmental factors.

It is also desirable that the biological data acquiring unit acquires biological data related to at least one of the user's body temperature, perspiration, heart rate, and breathing measured by the biological sensors.

Since the biological sensors measure at least one of the user's body temperature, perspiration, heart rate, and breathing with this construction, the biological data acquiring unit can produce more accurate inference data on the user.

It is also desirable that the environmental data acquiring unit acquire environmental data on at least one of temperature, humidity, and ambient light measured by environmental sensors.

Since the environmental sensors measure at least one of ambient temperature, humidity, and ambient light with this construction, the environmental data acquiring unit can produce more accurate inference data on the user.

Further, the biological data acquiring unit should be a first interfacing unit that acquires biological data from biological sensors via a wired or wireless connection. The environmental data acquiring unit should be a second interfacing unit that acquires environmental data from environmental sensors via a wired or wireless connection.

This construction includes the first interfacing unit that acquires biological data from biological sensors via a wired or wireless connection; and the second interfacing unit that acquires environmental data from environmental sensors via a wired or wireless connection. Hence, biological data can be effectively acquired from external biological sensors, and environmental data can be effectively acquired from external environmental sensors.

It is also possible to provide an inference information creating system including biological sensors that measures biological data of a user, environmental sensors that measures environmental data, and an inference information creating device that creats inference information on the user based on the biological data acquired from the biological sensors and the environmental data acquired from the environmental sensors, the inference information creating device being connected to the sensors via a network. The biological sensors comprise a biological data measuring unit that measures biological data; and a biological data transmitting unit that transmits biological data measured by the biological data measuring unit to the inference information creating device. The environmental sensors comprise an environmental data measuring unit that measures environmental data; and an environmental data transmitting unit that transmits environmental data measured by the environmental data measuring unit to the inference information creating device. The inference information creating device comprises a biological data acquiring unit that receives and acquires biological data transmitted from biological sensors; an environmental data acquiring unit that receives and acquiring environmental data transmitted from the environmental sensors; an inference information creating unit that creates inference data as an index value different from the biological data and environmental data based on the biological data acquired by the biological data acquiring unit and the environmental data acquired by the environmental data acquiring unit; and an inference information outputting unit that outputs inference information including the inference data created by the inference information creating unit.

With this construction, the biological sensors, environmental sensors, and inference information creating device are arranged independent of each other, and the inference information creating device creates inference information based on biological data and environmental data acquired from each of the external sensors. Accordingly, the inference information creating system can be configured with more freedom and flexibility and can create inference information based on biological and environmental data, which information is highly accurate and is less impacted by environmental factors.

It is also possible to provide an inference information creating program for instruction a computer to function as a biological data acquiring unit that acquires biological data from biological sensors that measure a user's biological data; an environmental data acquiring unit that acquires environmental data from environmental sensors that measure environmental data; an inference information creating unit that generates inference data as an index value different from the biological data and the environmental data based on the biological data acquired by the biological data acquiring unit and the environmental data acquired by the environmental data acquiring unit; and an inference information outputting unit that outputs inference information including the inference data created by the inference information creating unit.

A program having this configuration can create inference data as an index value that is different from biological data and environmental data based on biological data acquired from the biological sensors and environmental data acquired from environmental sensors and can output inference information including the inference data. Therefore, the program can create inference information based on biological data acquired from biological sensors and environmental data acquired from environmental sensors, which information is highly accurate and has less impact from environmental factors.

The inference information creating device, inference distribution map generating system, inference information management system, inference information creating system, and inference information creating program can be applied to a computer that infers a user's attitude, emotions, and the like.

What is claimed is:

1. An inference information creating device comprising:
a measured value acquiring unit that acquires a measured value from at least one sensor;
an inputting unit with which a user inputs data on an inference target;
a user input data acquiring unit that acquires user input data that the user inputs via the inputting unit; and
an inferring unit that infers the degree of the inference target, the inferring unit comprising an inference data creating unit that creates inference data, based on the measured value acquired by the measured value acquiring unit and the user input data acquired by the user input data acquiring unit, the inference data including an index value different from the measured value that indicates a degree of the inference target; and an inference information outputting unit that outputs inference information including the inference data created by the inference information creating unit.

2. The inference information creating device according to claim 1, wherein the inputting unit includes a switch.

3. The inference information creating device according to claim 2, wherein the inference data creating unit comprises at least one inference data creating unit, the inference unit further includes an inference procedure selecting unit that selects an inference data creating unit from the at least one inference data creating unit.

4. The inference information creating device according to claim 3, wherein the inferring unit further comprises:
an additional inference data creating unit that creates the inference data based on the measured value; and
the inference procedure selecting unit selects one inference data creating unit from among the at least one inference data creating unit and the additional inference data creating unit.

5. The inference information creating device according to claim 3, wherein one of the at least one inference data creating unit creates inference data based on the measured value upon acquiring the user input data indicative of a predetermined state.

6. The inference information creating device according to claim 3, wherein the inferring unit further comprises, an additional inference data creating unit that creates inference data based on the user input data, and the inference procedure selecting unit selects one inference data creating unit from among the at least one inference data creating unit and the additional inference data creating unit.

7. The inference information creating device according to claim 3, wherein one of the at least one inference data creating unit creates the inference data based on the user input data upon acquiring the user input data indicative of a predetermined state by the user input data acquiring unit and that creates the inference data based on the measured value upon acquiring the user indicative of another predetermined state.

8. The inference information creating device according to claim 3, wherein one of the at least one inference data creating unit creates inference results based on the measured value, and that creates inference data by calibrating the inference results based on the user input data upon acquiring the user input data indicative of a predetermined state.

9. The inference information creating device according to claim 3, wherein one of the at least one inference data creating unit creates inference results based on the measured value, and that creates inference data by setting a calibration value corresponding to the inference results and calibrating the inference results based on the calibration value upon acquiring the user input data indicative of a predetermined state.

10. The inference information creating device according to claim 7, wherein the index value indicates a degree of the inference information; and
when the user input data indicates the predetermined state, the inference data creating unit sets the index value to a maximum value that indicates a maximum degree of the inference target.

11. The inference information creating device according to claim 8, wherein the index value indicates the degree of the inference information; and
when the user input data indicates the predetermined state, the inference data creating unit calibrates the inference results to increase the index value.

12. The inference information creating device according to claim 9, wherein the index value indicates the degree of the inference information; and
when the user input data indicates the predetermined state, the inference data creating unit calibrates the inference results to increase the index value.

13. The inference information creating device according to claim 1, wherein the inferring unit includes at least one inferring unit.

14. The inference information creating device according to claim 1, wherein the measured value acquiring unit acquires the measured value for the user on at least one of his/her body temperature, heart rate, perspiration, and breathing measured by the sensor.

15. The inference information creating device according to claim 1, further comprising a position sensor that detects a current position of the user;
wherein the inference information outputting unit acquires position data on the current position that is measured by the position sensor when the inference data creating unit creates the inference data, and outputs the inference information including the position data.

16. The inference information creating device according to claim 1, further comprising a time-keeping unit that keeps the current date and time;
wherein the inference information outputting unit acquires time data for the current date and time that is kept by the time-keeping unit when the inference data creating unit creates the inference data, and outputs the inference information including the time data.

17. The inference information creating device according to claim 1, further comprising an ID data adding unit that adds to the inference data ID data unique to the inference data creating unit;
wherein the inference information outputting unit outputs inference information including the inference data to which the ID data is added.

18. The inference information creating device according to claim 1, further comprising an ID data adding unit that adds to the inference data ID data unique to the inferring unit;
wherein the inference information outputting unit outputs inference information including the inference data to which the ID data is added.

19. The inference information creating device according to claim 18, further comprising:
a characteristic data table that stores correlation between the ID data of the inferring unit and characteristic data indicating a feature of the inferring unit; and
a characteristic data acquiring unit that acquires the characteristic data from the characteristic data table corresponding to the ID data included in the inference information outputted by the inference information outputting unit.

20. The inference information creating device according to claim 19, wherein the characteristic data includes at least one of reliability, most recent update date, and inference type of the inferring unit.

21. The inference information creating device according to claim 19, further comprising:
at least one processing unit that processes the inference information outputted by the inference information outputting unit; and
a process procedure selecting unit that selects one of the at least one processing unit based on the characteristic data acquired by the characteristic data acquiring unit, and
wherein the processing unit selected by the process procedure selecting unit processes the inference information outputted by the inference information outputting unit.

22. The inference information creating device according to claim 20, further comprising:
at least one processing unit that processes the inference information outputted by the inference information outputting unit; and
a process procedure selecting unit that selects one of the at least one processing unit based on the characteristic data acquired by the characteristic data acquiring unit, and
wherein the processing unit selected by the process procedure selecting unit processes the inference information outputted by the inference information outputting unit.

23. The inference information creating device according to claim 1, wherein the at least one sensor comprises a biological sensor that measures a user's biological data, and an environmental sensor that measures environmental data;
the measured value acquiring unit comprises a biological data acquiring unit that acquires the biological data from the biological sensor, and an environmental data acquiring unit that acquires the environmental data from the environmental sensor; and
the inference data creating unit creates inference data based on the biological data acquired by the biological data acquiring unit, the environmental data acquired by the environmental data acquiring unit, and the user input data acquired by the user input data acquiring unit, the inference data being an index value that is different from the biological data and the environmental data and that indicates a degree of the inference target.

24. The inference information creating device according to claim 23, wherein the inference data creating unit calibrates the biological data using the environmental data and creates the inference data based on the post-calibration biological data.

25. The inference information creating device according to claim 23, wherein the biological data acquiring unit acquires the biological data for the user on at least one of his/her body temperature, heart rate, perspiration, and breathing measured by the biological sensors.

26. The inference information creating device according to claim 24, wherein the biological data acquiring unit acquires the biological data for the user on at least one of his/her body temperature, heart rate, perspiration, and breathing measured by the biological sensors.

27. The inference information creating device according to claim 23, wherein the environmental data acquiring unit acquires environmental data on at least one of temperature, humidity, and illuminance of an environment measured by the environmental sensor.

28. The inference information creating device according to claim 24, wherein the environmental data acquiring unit acquires environmental data on at least one of temperature, humidity, and illuminance of an environment measured by the environmental sensor.

29. The inference information creating device according to claim 23, wherein the biological data acquiring unit comprises a first interfacing unit that acquires the biological data from the biological sensor via a wired or wireless network; and
the environmental data acquiring unit comprises a second interfacing unit that acquires the environmental data from the environmental sensor via another wired or wireless network.

30. The inference information creating device according to claim 23, wherein the biological data acquiring unit comprises a first interfacing unit that acquires the biological data from the biological sensor via a wired or wireless network; and
the environmental data acquiring unit comprises a second interfacing unit that acquires the environmental data from the environmental sensor via another wired or wireless network.

31. An inference information management system comprising:
an inference information creating device that creates inference information indicating a degree of an inference target; and
an inference information management device that is connected to the inference information creating devices via a network and that manages the inference information created by the inference information creating device;
the inference information creating device comprising
a measured value acquiring unit that acquires a measured value from at least one sensor;
an inputting unit that allows a user to input data on the inference target;
a user input data acquiring unit that acquires user input data that the user inputs via the inputting unit; and
an inferring unit that infers a degree of the inference target;
the inferring unit comprising:
an inference data creating unit that creates inference data based on the measured value acquired by the measured value acquiring unit and the user input data acquired by the user input data acquiring unit, the inference data being an index value that is different from the measured value and that indicates a degree of the inference target; and
an inference information outputting unit that outputs inference information including the inference data created by the inference information creating unit;
the inference information management device comprising:
an inference information acquiring unit that acquires the inference information outputted from the inference information creating devices via the network; and
an inference information storing unit that stores the inference information acquired by the inference information acquiring unit.

32. The inference information management system according to claim 31, wherein the inference information management device further comprises an inference distribution map generating unit that generates an inference distribution map for the inference information based on the inference information stored in the inference information storing unit.

33. The inference information management system according to claim 32, wherein the inference information creating device further comprises a position sensor that detects a current position of the user;
the inference information outputting unit acquires position data on the current position that is detected by the position sensor when the inference data creating unit creates the inference data, and outputs the inference information including the position data; and
the inference distribution map generating unit generates the inference distribution map for the inference information based on the position data included in the inference information.

34. The inference information management system according to claim 32, wherein the inference information creating device further comprises a time-keeping unit that keeps the current date and time;
the inference information outputting unit acquires time data for the current date and time that is kept by the time-keeping unit when the inference data creating unit creates the inference data, and outputs the inference information including the time data; and
the inference distribution map generating unit generates the inference distribution map for the inference information based on the time data included in the inference information.

35. The inference information management system according to claim 31, wherein the inferring unit comprises an ID data adding unit that adds to the inference data ID data unique to the inferring unit;
the inference information outputting unit outputs the inference information including the inference data to which the ID data is added; and
the inference information management device further comprises:
a characteristic data table that stores correlation between the ID data of the inferring unit and characteristic data indicating a feature of the inferring unit; and
a characteristic data acquiring unit that acquires the characteristic data from the characteristic data table corresponding to the ID data included in the inference information outputted by the inference information outputting unit.

36. The inference information management system according to claim 35, wherein the characteristic data includes at least one of reliability, most recent update date, and inference type of the inferring unit.

37. The inference information management system according to claim 35, wherein the inference information management device further comprises:
at least one processing unit that processes the inference information; and
a process procedure selecting unit that selects one of the at least one processing unit based on the characteristic data acquired by the characteristic data acquiring unit; and
the processing unit selected by the process procedure selecting unit processes the inference information outputted by the inference information outputting unit.

38. The inference information management system according to claim 36, wherein the inference information management device further comprises:
at least one processing unit that processes the inference information; and
a process procedure selecting unit that selects one of the at least one processing unit based on the characteristic data acquired by the characteristic data acquiring unit; and
the processing unit selected by the process procedure selecting unit processes the inference information outputted by the inference information outputting unit.

39. The inference information management system according to claim 35, wherein the inference information outputting unit comprises a first communication interfacing unit that performs data communications with the inference information management device through a wired or wireless connection; and
the inference information acquiring unit comprises a second communication interfacing unit that performs data communications with the inference information creating device through the wired or wireless connection.

40. The inference information management system according to claim 36, wherein the inference information outputting unit comprises a first communication interfacing unit that performs data communications with the inference information management device through a wired or wireless connection; and
the inference information acquiring unit comprises a second communication interfacing unit that performs data communications with the inference information creating device through the wired or wireless connection.

41. The inference information management system according to claim 31, wherein the sensor comprises a biological sensor that measures a user's biological data, and an environmental sensor that measures environmental data;
the measured value acquiring unit comprises a biological data acquiring unit that acquires the biological data from the biological sensor, and an environmental data acquiring unit that acquires the environmental data from the environmental sensor; and
the inference data creating unit creates the inference data based on the biological data acquired by the biological data acquiring unit, the environmental data acquired by the environmental data acquiring unit, and the user input data acquired by the user input data acquiring unit, the inference data being an index value that is different from the biological data and the environmental data and that indicates a degree of the inference target.

42. An inference information creating system comprising:
a biological sensor that measures a user's biological data;
an environmental sensor that measures environmental data; and
an inference information creating device that is connected to the biological sensor and the environmental sensor via a network and that creates inference information on the user based on the biological data acquired from the biological sensor and the environmental data acquired from the environmental sensor;
the biological sensor comprising:
a biological data measuring unit that measures biological data; and
a biological data transmitting unit that transmits the biological data measured by the biological data measuring unit to the inference information creating device;
the environmental sensors comprising:
an environmental data measuring unit that measures environmental data; and
an environmental data transmitting unit that transmits the environmental data measured by the environmental data measuring unit to the inference information creating device;
the inference information creating device comprising:
a biological data acquiring unit that receives and acquires biological data transmitted from the biological sensors;
an environmental data acquiring unit that receives and acquires environmental data transmitted from the environmental sensors;
an inputting unit that allows a user to input data on an inference target;
a user input data acquiring unit that acquires user input data that the user has inputted via the inputting unit; and
an inferring unit that infers a degree of the inference target; and
the inferring unit comprising:
an inference data creating unit that creates inference data based on the biological data acquired by the biological data acquiring unit, the environmental data acquired by the environmental data acquiring unit, and the user input data acquired by the user input data acquiring unit, the inference data being an index value that is different from the biological data and the environmental data; and
an inference information outputting unit that outputs inference information including the inference data created by the inference data creating unit.

43. A computer readable product containing an inference information creating program for instructing a computer to function as:
a measured value acquiring unit that acquires measured value from at least one sensor;
a user input data acquiring unit that acquires user input data inputted by the user via an inputting unit that enables a user to input data on an inference target;
an inferring unit that infers a degree of the inference target by creating the inference data based on the measured value and the user input data, the inference data being an index value that is different from the measured value; and
an inference information outputting unit that outputs the inference information including the inference data.

44. A method of generating inference information comprising:
acquiring a measured value from at least one sensor;
acquiring user input data on an inference target;
creating inference data based on the measured value and the user input data, the inference data being an index value that is different from the measured value; and
outputting inference information including the inference data.
